(19) United States
(12) Patent Application Publication
(10) Pub. No.: US 2016/0052498 A1
(43) Pub. Date: Feb. 25, 2016

(54) Brake-Hydraulic-Pressure Control Device

(71) Applicant: TOYOTA JIDOSHA KABUSHIKI KAISHA, Toyota-shi (JP)

(72) Inventor: Hiroshi ISONO, Susono-shi (JP)

(73) Assignee: TOYOTA JIDOSHA KABUSHIKI KAISHA, Toyota-shi (JP)

(21) Appl. No.: 14/810,839

(22) Filed: Jul. 28, 2015

(30) Foreign Application Priority Data
Aug. 21, 2014 (JP) 2014-168246

(51) Int. Cl. B60T 13/68; B60T 13/14

(52) U.S. Cl. CPC B60T 13/686; B60T 13/142; B60T 13/148

(57) ABSTRACT

A brake-hydraulic-pressure control device includes: a regulator including a movable member which is driven by input hydraulic pressure as hydraulic pressure in an input chamber, the regulator being capable of controlling output hydraulic pressure using movement of the movable member; and an input-hydraulic-pressure control device capable of controlling the input hydraulic pressure to control hydraulic pressure in a plurality of brake cylinders. The plurality of brake cylinders include at least one brake cylinder as a first brake cylinder connected to the input chamber.

### CROSS REFERENCE TO RELATED APPLICATION

The present application claims priority from Japanese Patent Application No. 2014-168246, which was filed on Aug. 21, 2014, the disclosure of which is herein incorporated by reference in its entirety.

### BACKGROUND

1. Technical Field

The following disclosure relates to a brake-hydraulic-pressure control device.

2. Description of the Related Art

Patent Document 1 (Japanese Patent Application Publication No. 2013-227016) discloses a brake-hydraulic-pressure control device in which a plurality of brake cylinders are connected to a pressure chamber formed in front of a pressurizing piston of a master cylinder, and a regulator is connected to a rear chamber formed at a rear of the pressurizing piston. In the regulator, a spool is moved by hydraulic pressure in an input chamber, namely, input hydraulic pressure, to control output hydraulic pressure. An accumulator is connected to the input chamber via a linear valve, and the input hydraulic pressure is controlled, using hydraulic pressure in the accumulator, by control of the linear valve. The output hydraulic pressure is controlled by the control of the input hydraulic pressure to control hydraulic pressure in the rear chamber and hydraulic pressure in the brake cylinders.

### SUMMARY

An object of the disclosure is to improve a brake-hydraulic-pressure control device, for example, controllability of input hydraulic pressure.

In one aspect of the disclosure, a brake-hydraulic-pressure control device includes a regulator in which hydraulic pressure in an input chamber, namely, input hydraulic pressure moves a movable member to control output hydraulic pressure. At least one brake cylinder is connected to the input chamber of the regulator. The input hydraulic pressure is controlled by an input-hydraulic-pressure control device.

The stiffness of the working fluid in the input chamber is large (noted that the stiffness is obtained by dividing an amount of change in hydraulic pressure by an amount of change in an amount of the working fluid). Thus, when working fluid is supplied to the input chamber at a high flow rate, satisfactory control of the input hydraulic pressure is difficult due to, e.g., rapid increase in the input hydraulic pressure. However, the stiffness of working fluid in the input chamber can be reduced by connecting at least one brake cylinder to the input chamber. This reduction of the stiffness can satisfactorily reduce rapid increase in the input hydraulic pressure, thereby improving controllability of the input hydraulic pressure. On the other hand, the regulator can be configured to have a damper chamber capable of absorbing change in the hydraulic pressure in the input chamber, but other problems are caused such as a complicated construction of the regulator. In contrast, the present brake-hydraulic-pressure control device eliminates the need for forming a damper chamber in the regulator, avoiding a complicated construction of the regulator accordingly.

### CLAIMABLE INVENTIONS

(1) A brake-hydraulic-pressure control device, comprising:

a regulator comprising a movable member which is driven by input hydraulic pressure as hydraulic pressure in an input chamber, the regulator being capable of controlling output hydraulic pressure using movement of the movable member; and

an input-hydraulic-pressure control device capable of controlling the input hydraulic pressure to control hydraulic pressure in a plurality of brake cylinders,

the plurality of brake cylinders comprising at least one brake cylinder as a first brake cylinder connected to the input chamber.

Each of the plurality of brake cylinders may be used as a constituent element of a hydraulic brake which is directly or indirectly operated using at least one of the input hydraulic pressure and the output hydraulic pressure of the regulator. Examples of the plurality of brake cylinders include: a brake cylinder connected to the regulator, i.e., a brake cylinder to which the input hydraulic pressure or the output hydraulic pressure is supplied; and a brake cylinder connected to a hydraulic-pressure producing device (e.g., a master cylinder) which is operated by the output hydraulic pressure output from the regulator.

(2) The brake-hydraulic-pressure control device according to the above form (1),

wherein the input-hydraulic-pressure control device comprises:

at least one electromagnetic valve each provided between the input chamber and at least one of a high pressure source and a low pressure source; and

an electromagnetic valve controller configured to control the at least one electromagnetic valve to control the input hydraulic pressure, and

wherein the brake-hydraulic-pressure control device further comprises a first brake-cylinder hydraulic controller configured to control the at least one electromagnetic valve to control hydraulic pressure in the first brake cylinder.

The electromagnetic valve may be provided between the input chamber and the high pressure source, between the input chamber and the low pressure source, or among the input chamber, the high pressure source, and the low pressure source. Also, the electromagnetic valve may be (i) an electromagnetic open/close valve which is opened and closed by selectively supplying or not supplying a current to a coil of the valve, (ii) a linear valve configured to control a hydraulic pressure difference between the input chamber and the high pressure source or a hydraulic pressure difference between the input chamber and the low pressure source, to a magnitude which is proportional to a magnitude of a current supplied to the coil, or (iii) a direction switching valve configured to cause one of the high pressure source and the low pressure source to selectively communicate with the input chamber, for example.

(3) The brake-hydraulic-pressure control device according to the above form (2), wherein the high pressure source comprises an accumulator configured to accumulate working fluid in a state in which pressure of the working fluid is greater than or equal to set pressure.

The low pressure source may be a reservoir configured to keep the working fluid at substantially the atmospheric pressure.

The input hydraulic pressure is increased, by control of the electromagnetic valve, using accumulator pressure which is hydraulic pressure of the working fluid stored in the accumulator. At a start of the pressure increase, however, a large difference between the input hydraulic pressure and the accumulator pressure can supply the working fluid to the input chamber at a high flow rate, which can result in rapid increase in the input hydraulic pressure. Also, control hunting may occur due to the rapid increase in the hydraulic pressure, making it difficult to control the hydraulic pressure well. In contrast, the stiffness of the working fluid in the input chamber can be reduced by connecting the first brake cylinder to the input chamber. This construction can reduce the rapid increase in the input hydraulic pressure, enabling satisfactory control of the input hydraulic pressure. A damper function of the brake cylinder can reduce fluctuations of the input hydraulic pressure well.

(4) The brake-hydraulic-pressure control device according to the above form (1),

wherein the input-hydraulic-pressure control device comprises:

a pump capable of supplying discharged working fluid to the input chamber;

a pump motor configured to drive the pump; and

a return-flow control valve as an electromagnetic valve provided on a return flow passage connecting between a discharge side and a suction side of the pump, and

wherein the input-hydraulic-pressure control device is configured to control at least one of the return-flow control valve and the pump motor to control the input hydraulic pressure.

The input hydraulic pressure is controlled by control of the return-flow pump device. The return-flow pump device includes the pump, the pump motor, and the return-flow control valve and is configured such that the working fluid discharged from the pump is returned to its suction side via the return flow passage and discharged from the pump again. That is, the return-flow pump causes back flow of the working fluid or circulates the working fluid. The suction side of the pump includes a low pressure source in the case where the pump pumps up the working fluid out of the low pressure source and discharges the working fluid. The discharge side of the pump includes the input chamber in the case where the working fluid discharged from the pump is supplied to the input chamber. One example of the return-flow control valve is a variable relief valve in which relief pressure, i.e., valve opening pressure, is determined by a current supplied to a coil of the valve. The supply current is controlled to control the valve opening pressure, thereby controlling hydraulic pressure in the input chamber. Also, a current supplied to the pump motor can be controlled to control the flow rate of the working fluid discharged from the pump, thereby controlling an increase gradient of the input hydraulic pressure.

(5) The brake-hydraulic-pressure control device according to any one of the above forms (1) through (4), wherein the output hydraulic pressure output from the regulator is suppliable to a rear chamber formed at a rear of a pressurizing piston of a master cylinder.

The output hydraulic pressure output from the regulator is supplied to the rear chamber, so that the pressurizing piston is advanced by a forward force related to at least hydraulic pressure in the rear chamber (noted that this forward force is obtained by multiplying the hydraulic pressure in the rear chamber by a portion of the pressurizing piston which receives the hydraulic pressure in the rear chamber).

(6) The brake-hydraulic-pressure control device according to the above form (5),

wherein the plurality of brake cylinders comprise at least one brake cylinder other than the first brake cylinder, as a second brake cylinder connected to a pressure chamber formed in front of the pressurizing piston, and

wherein the first brake cylinder is provided on each of rear left and right wheels of a vehicle, and the second brake cylinder is provided on each of front left and right wheels of the vehicle.

For fail-safe, it is appropriate that the brake cylinders provided on the front wheels are connected to the pressure chamber of the master cylinder.

Also, the brake-hydraulic-pressure control device may include a second brake-cylinder hydraulic controller configured to control the input hydraulic pressure to control the output hydraulic pressure and the hydraulic pressure in the rear chamber to control hydraulic pressure in the second brake cylinder.

(7) The brake-hydraulic-pressure control device according to any one of the above forms (1) through (6),

wherein the regulator comprises:

a housing;

a pilot piston fluid-tightly and slidably fitted in the housing and disposed at a rear of the movable member, with the input chamber interposed between the pilot piston and the movable member, the pilot piston being movable forward by pilot pressure;

a low pressure port formed in the housing and connected to the low pressure source; and

an interrupting mechanism configured to cause the input chamber and the low pressure port to communicate with each other when the pilot piston is located at a back end position thereof, the interrupting mechanism configured to isolate the input chamber from the low pressure port when the pilot piston is moved forward.

For example, an electromagnetic valve in the form of a pressure reduction valve may be provided between the low pressure port and the low pressure source.

The pilot piston receives the pilot pressure in the forward direction and the input hydraulic pressure in the backward direction. The pilot piston is normally located at its back end position in a state in which the input hydraulic pressure is controllable without malfunction in an electrical system. The input chamber and the low pressure port are in communication with each other, and the input hydraulic pressure is controlled by control of the pressure reduction valve.

On the other hand, the pilot piston is moved forward by the pilot pressure in a state in which the input hydraulic pressure is not controllable, for example, in the event of, e.g., malfunction in the electrical system. This forward movement isolates the input chamber from the low pressure port, enabling production of the hydraulic pressure in the input chamber. The input hydraulic pressure can be made substantially equal in magnitude to the pilot pressure. One example of the pilot pressure is hydraulic pressure in the pressure chamber of the master cylinder, which pressure can be produced even in the event of malfunction in the electrical system. In this case, hydraulic pressure equal in magnitude to the hydraulic pressure in the pressure chamber can be supplied to the first brake cylinder.

(8) The brake-hydraulic-pressure control device according to any one of the above forms (1) through (7),

wherein the regulator comprises a housing and an output port formed in the housing to output the output hydraulic pressure,

wherein the regulator is configured to use movement of the movable member to cause one of a high pressure source and a low pressure source to communicate selectively with the output port to control the output hydraulic pressure based on the input hydraulic pressure, and

wherein the high pressure source comprises an accumulator configured to accumulate working fluid in a state in which pressure of the working fluid is greater than or equal to set pressure.

(9) The brake-hydraulic-pressure control device according to the above form (8), wherein the accumulator is connected to the input chamber.

The regulator may be of a spool type or a poppet valve type, and the movable member may be constituted by a spool or a poppet-valve driving member for opening and closing a poppet valve. Also, working fluid at high pressure is preferably supplied quickly from the high pressure source to the output port by the movement of the movable member. Accordingly, it is appropriate that the accumulator is provided for the high pressure source.

The accumulator is a constituent element of the high pressure source, but accumulator pressure may be used for control of the input hydraulic pressure.

(10) The brake-hydraulic-pressure control device according to any one of the above forms (1) through (9),

wherein the movable member is a spool, and

wherein the regulator comprises a spool driving member comprising:

a large diameter portion comprising a pressure receiving face which receives hydraulic pressure in the input chamber; and

an engaging portion engageable with a rear end portion of the spool which is less in diameter than the large diameter portion.

The hydraulic pressure in the input chamber is transmitted to the spool via the spool driving member. Since the pressure receiving face for receiving the hydraulic pressure in the input chamber is provided on the large diameter portion of the spool driving member, the hydraulic pressure in the input chamber can be effectively transmitted to the spool.

(11) The brake-hydraulic-pressure control device according to any one of the above forms (1) through (10),

wherein the movable member is a spool, and

wherein the regulator comprises a balance piston configured to apply a backward force to the spool.

The spool receives the force related to the input hydraulic pressure in the forward direction and the force related to the output hydraulic pressure in the backward direction, so that the spool is moved to a position at which these forces are balanced with each other.

(12) The brake-hydraulic-pressure control device according to any one of the above forms (1) through (9),

wherein the regulator comprises:

a housing;

an output port formed in the housing to output the output hydraulic pressure; and

a poppet high-pressure supply valve provided between the output port and a high pressure chamber connected to a high pressure source, and

wherein the regulator is configured to use movement of the movable member to open and close the poppet high-pressure supply valve to control the output hydraulic pressure to a magnitude determined based on the input hydraulic pressure.

(13) A brake-hydraulic-pressure control device, comprising:

a regulator comprising a movable member which is driven by input hydraulic pressure as hydraulic pressure in an input chamber, the regulator being capable of controlling output hydraulic pressure using movement of the movable member;

an input-hydraulic-pressure control device capable of controlling the input hydraulic pressure to control hydraulic pressure in a plurality of brake cylinders; and

a stiffness reducing mechanism configured to reduce stiffness in the input chamber.

For example, the stiffness in the input chamber can be reduced by connecting a hydraulic-pressure consuming device to the input chamber.

The technical features according to any one of the above forms (1) through (12) may be employed for the brake-hydraulic-pressure control device in the present form.

(14) A hydraulic brake system, comprising:

a master cylinder comprising a pressurizing piston;

a plurality of brake cylinders; and

the brake-hydraulic-pressure control device according to any one of the above forms (1) through (13),

the master cylinder comprising a rear chamber provided at a rear of the pressurizing piston,

the output hydraulic pressure output from the regulator being suppliable to the rear chamber,

the plurality of brake cylinders comprising at least one brake cylinder other than the first brake cylinder, as a second brake cylinder connected to a pressure chamber formed in front of the pressurizing piston of the master cylinder,

the first brake cylinder provided on each of rear left and right wheels of a vehicle,

the second brake cylinder provided on each of front left and right wheels of the vehicle.

(15) The hydraulic brake system according to the above form (14),

wherein the pressurizing piston is movable forward in response to an operation of a brake operating member, and

wherein the master cylinder comprises a first fill mechanism configured to make a ratio of a stroke of the pressurizing piston to a stroke of the brake operating member greater when hydraulic pressure in the pressure chamber is less than set pressure than when the hydraulic pressure in the pressure chamber is greater than or equal to the set pressure.

The brake cylinder is characterized such that the hydraulic pressure therein is substantially zero while an amount of working fluid supplied to the brake cylinder is smaller than a set amount (which may be referred to as “ineffective fluid amount”), but the hydraulic pressure in the brake cylinder is increased with supply of the working fluid when the amount of working fluid supplied to the brake cylinder is larger than or equal to the set amount. In the hydraulic brake system in the present form, in contrast, the stroke of the pressurizing piston with respect to the stroke of the brake operating member is increased at a start of operation of the brake operating member, resulting in a large amount of working fluid supplied to the brake cylinder connected to the pressure chamber formed in front of the pressurizing piston. With this construction, the working fluid with an amount larger than or equal to the set amount can be quickly supplied to the brake cylinder, enabling quick completion of first fill, thereby satisfactorily reducing an amount of delay in brake response.

It is noted that the pressurizing piston is movable forward by an operation of the brake operating member from the time before hydraulic pressure is supplied from the regulator to the rear chamber.

(16) The hydraulic brake system according to the above form (14) or (15),

wherein the pressurizing piston comprises a pressurizing face which pressurizes hydraulic pressure in the pressure chamber, and

wherein the master cylinder is configured such that an area of the pressurizing face of the pressurizing piston is greater when the hydraulic brake system is normal than when an electrical system is in malfunction.

In the case where the hydraulic brake system is normal, a large-diameter pressurizing state is established (in which the area of the pressurizing face is substantially large). This construction can reduce the stroke of the pressurizing piston in the case of the same amount of working fluid supplied to the brake cylinder connected to the pressure chamber. Also, in the event of malfunction in the electrical system, a small-diameter pressurizing state is established (in which the area of the pressurizing face is substantially small). This construction can increase the hydraulic pressure in the pressure chamber in the case of the same forward force applied to the pressurizing piston, thereby making the hydraulic brake system more fail-safe.

It is noted that the pressurizing piston may be constituted by one component or a plurality of components movable relative to each other, for example.

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIG. 1 is a circuit diagram of a hydraulic brake system including a brake-hydraulic-pressure control device according to a first embodiment;

FIG. 2 is a view illustrating a brake ECU of the hydraulic brake system and devices connected to the brake ECU;

FIG. 3 is a flow chart illustrating a brake-hydraulic-pressure control program stored in a storage device of the brake ECU;

FIG. 4 is a circuit diagram of a hydraulic brake system including a brake-hydraulic-pressure control device according to a second embodiment;

FIG. 5 is a circuit diagram of a hydraulic brake system including a brake-hydraulic-pressure control device according to a third embodiment;

FIG. 6 is a circuit diagram of a hydraulic brake system including a brake-hydraulic-pressure control device according to a fourth embodiment;

FIG. 7 is a circuit diagram of a hydraulic brake system including a brake-hydraulic-pressure control device according to a fifth embodiment;

FIGS. 8A and 8B are schematic views each illustrating an electromagnetic valve of the hydraulic brake system, wherein FIG. 8A illustrates the electromagnetic valve in a non-energized state, and FIG. 8B illustrates the electromagnetic valve in an energized state;

FIG. 9 is a view illustrating the brake ECU of the hydraulic brake system and devices connected to the brake ECU;

FIG. 10 is a table stored in the storage device of the brake ECU and representing a relationship between a pressure differential and an amount of current supplied to the electromagnetic valve;

FIG. 11 is a view illustrating operations of the hydraulic brake system;

FIG. 12 is a circuit diagram of a hydraulic brake system including a brake-hydraulic-pressure control device according to a sixth embodiment; and

FIG. 13 is a view illustrating operations of the hydraulic brake system.

### DETAILED DESCRIPTION OF THE EMBODIMENTS

Hereinafter, there will be described a hydraulic brake system including a brake-hydraulic-pressure control device according to one embodiment by reference to the drawings.

### First Embodiment

### Configuration of Hydraulic Brake System

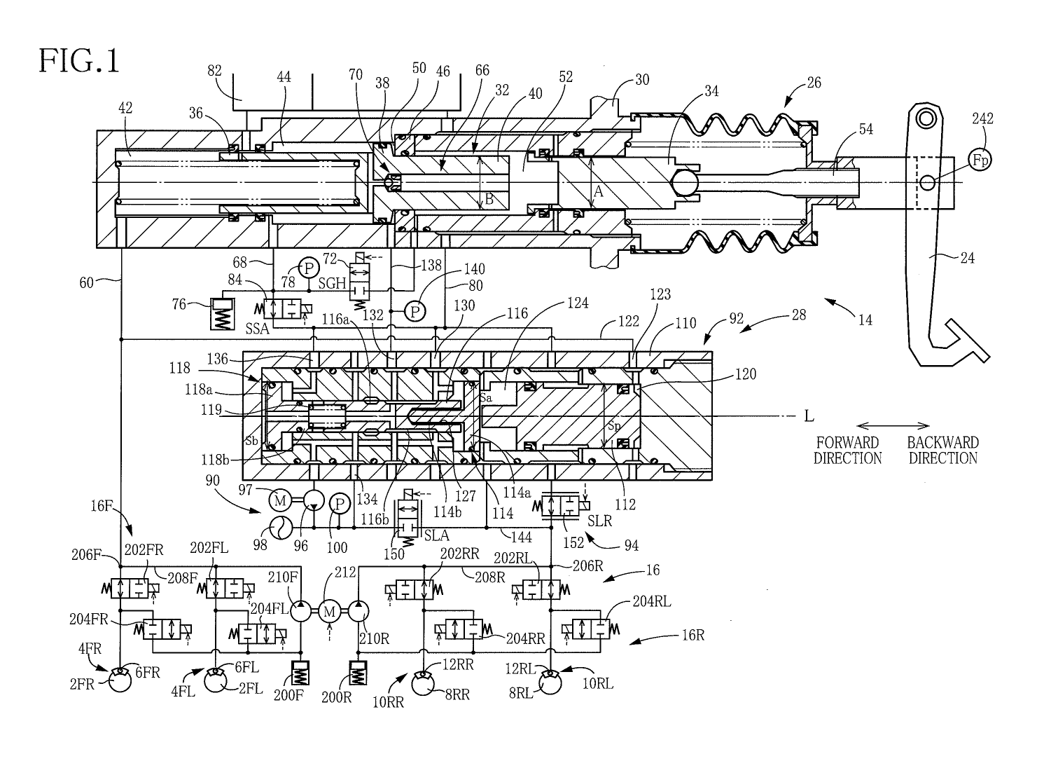

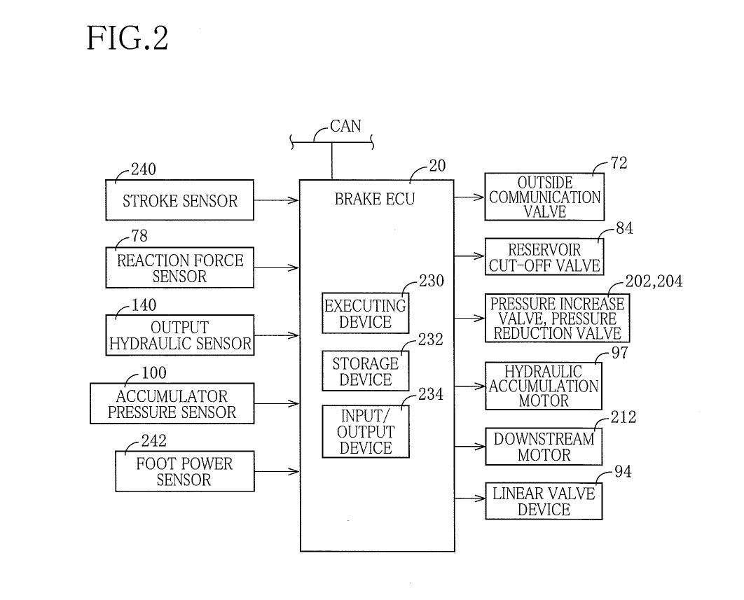

As illustrated in FIG. 1, the hydraulic brake system includes: brake cylinders 6FL, 6FR of hydraulic brakes 4FL, 4FR provided on respective front left and right wheels 2FL, 2FR; brake cylinders 12RL, 12RR of hydraulic brakes 10RL, 10RR provided on respective rear left and right wheels 8RL, 8RR; a hydraulic-pressure producing device 14 capable of supplying hydraulic pressure to these brake cylinders 6FL, 6FR, 12RL, 12RR; and a slip control device 16 provided between the hydraulic-pressure producing device 14 and the brake cylinders 6FL, 6FR, 12RL, 12RR. Devices including the hydraulic-pressure producing device 14 and the slip control device 16 are controlled by a brake ECU 20 (see FIG. 2) mainly constituted by a computer.

Hydraulic-Pressure Producing Device

The hydraulic-pressure producing device 14 includes: a brake pedal 24 as a brake operating member; a master cylinder 26; and a rear-hydraulic-pressure control device 28 configured to control hydraulic pressure in a rear chamber 50 of the master cylinder 26.

Master Cylinder

The master cylinder 26 includes: a housing 30; and a pressurizing piston 32 and an input piston 34 arranged in series and fluid-tightly and slidably fitted in a cylinder bore formed in the housing 30.

The pressurizing piston 32 includes: a front piston portion 36 provided at a front portion thereof; an intermediate piston portion 38 provided at an intermediate portion of the pressurizing piston 32 and protruding in a radial direction; and a rear small-diameter portion 40 provided at a rear portion of the pressurizing piston 32 and smaller in diameter than the intermediate piston portion 38. The front piston portion 36 and the intermediate piston portion 38 are fluid-tightly and slidably fitted in the housing 30. A space formed in front of the front piston portion 36 is a front pressure chamber (hereinafter may be simply referred to as “pressure chamber”) 42. A space defined in front of the intermediate piston portion 38 is an annular chamber 44.

The housing 30 has an annular inner-circumferential-side protruding portion 46. The portion located at the rear of the intermediate piston portion 38, namely, the rear small-diameter portion 40 is fluid-tightly and slidably fitted in the inner-circumferential-side protruding portion 46. The rear chamber 50 is formed at the rear of the intermediate piston portion and between the intermediate piston portion 38 and the inner-circumferential-side protruding portion 46. The input piston 34 is located at a rear of the pressurizing piston 32, and a separated chamber 52 is formed between the rear small-diameter portion 40 and the input piston 34. The brake pedal 24 is coupled to a rear portion of the input piston 34 by, e.g., an operating rod 54.

In view of the above, it is possible to consider that components including the front piston portion 36 and the intermediate piston portion 38 are one example of a pressurizing piston. Also, the front piston portion 36 and the intermediate piston portion 38 may be respectively provided on different components which are movable relative to each other.

The brake cylinders 6FL, 6FR of the hydraulic brakes 4FL, 4FR provided on the respective front left and right wheels 2FL, 2FR are connected to the pressure chamber 42 via a front-wheel brake passage 60. Hydraulic pressure supplied to the brake cylinders 6FL, 6FR actuates the respective hydraulic brakes 4FL, 4FR to restrain rotation of the respective wheels 2FL, 2FR. In the following description, each of components such as the hydraulic brakes and electromagnetic valves, which will be described below, will be referred without a corresponding one of suffixes (FL, FR, RL, RR) indicative of the respective front left, front right, rear left, and rear right wheels where these components do not need to be distinguished by their respective wheel positions or where the components are collectively referred, for example. Also, the brake cylinders 6 of the hydraulic brakes 4 provided on the respective front wheels 2 may be referred to as “front-wheel brake cylinders 6”, and the brake cylinders 12 of the hydraulic brakes 10 provided on the respective rear wheels 8 may be referred to as “rear-wheel brake cylinders 12”.

The annular chamber 44 and the separated chamber 52 are connected to each other by an inside passage 66 and an outside passage 68. The inside passage 66 is provided inside the pressurizing piston 32, and the outside passage 68 is provided outside the housing 30. An inside communication valve 70 is provided in the inside passage 66, and an outside communication valve 72 is provided in the outside passage 68. The inside communication valve 70 is a mechanical open/close valve which is switched from a closed state to an open state to allow working fluid to flow from the annular chamber 44 to the separated chamber 52 when hydraulic pressure in the annular chamber 44 exceeds hydraulic pressure in the separated chamber 52. The outside communication valve 72 is a normally closed electromagnetic open/close valve which is opened and closed by selectively supplying and not supplying a current to a coil of the outside communication valve 72.

A stroke simulator 76 is connected to and a hydraulic sensor 78 is provided in a portion of the outside passage 68 which is nearer to the annular chamber 44 than the outside communication valve 72. The portion is connected via a reservoir passage 80 to a master reservoir 82 as a low pressure source. The hydraulic sensor 78 detects the hydraulic pressure in the annular chamber 44 or the separated chamber 52, and this hydraulic sensor 78 may be referred to as “reaction force sensor”. A reservoir cut-off valve 84 is provided in the reservoir passage 80. The reservoir cut-off valve 84 is a normally open electromagnetic open/close valve which is opened and closed by selectively supplying or not supplying a current to a coil of the reservoir cut-off valve 84.

It is noted that the working fluid is allowed to flow from the annular chamber 44 to the separated chamber 52 via the inside communication valve 70 to move the pressurizing piston 32 forward in the case where the hydraulic pressure in the annular chamber 44 has been increased with a large gradient, or the case where the hydraulic pressure in the annular chamber 44 becomes high in a state in which each of the reservoir cut-off valve 84 and the outside communication valve 72 is in its closed state.

Rear-Hydraulic-Pressure Control Device

The rear-hydraulic-pressure control device 28 includes a high pressure source 90, a regulator 92, and a linear valve device 94.

The high pressure source 90 includes: a hydraulic accumulation pump device which includes a hydraulic accumulation pump 96 and a hydraulic accumulation motor 97 configured to drive the hydraulic accumulation pump 96; and an accumulator 98 configured to accumulate or store the working fluid discharged from the hydraulic accumulation pump 96, in a state in which pressure of the working fluid is equal to or higher than set pressure. An accumulator pressure sensor 100 detects accumulator pressure which is hydraulic pressure of the working fluid accumulated in the accumulator 98. The hydraulic accumulation motor 97 is controlled so as to keep this accumulator pressure within a predetermined range. For example, the hydraulic accumulation motor 97 may be configured to be actuated when the accumulator pressure becomes lower than the lower limit value of the predetermined range, and be stopped when the accumulator pressure reaches the upper limit value of the predetermined range. Thus, the hydraulic accumulation pump device is one kind of a containment pump, and the working fluid discharged from the hydraulic accumulation pump 96 is principally supplied to the accumulator 98.

The accumulator 98 accumulates the working fluid in the state in which the pressure of the working fluid is equal to or higher than the lower limit value of the predetermined range as described above, and accordingly it is possible to consider that the lower limit value corresponds to set pressure described in Claims. Also, the working fluid starts to be supplied to the accumulator 98 when the pressure of the working fluid in the accumulator 98 becomes equal to or higher than the lowest pressure that is determined by initial pressure or an initial load of an elastic element of the accumulator 98 such as air or a spring, for example. Accordingly, the lowest pressure may be used as the set pressure described in Claims.

It is noted that a relief valve, not shown, is provided between a discharge side and a suction side of the hydraulic accumulation pump 96, and the working fluid ejected from the hydraulic accumulation pump 96 is returned to the suction side in the event of a malfunction, such as the case where a discharge pressure of the hydraulic accumulation pump 96 becomes excessively large.

The regulator 92 includes a housing 110, a pilot piston 112, a spool driving member 114, a spool 116 as a movable member, and an opposed piston 118 as a balance piston. The pilot piston 112, the spool driving member 114, the spool 116, and the opposed piston 118 are provided in the housing 110 and arranged in parallel with an axis L. The housing 110 has a stepped cylinder bore and has a small diameter portion at an intermediate portion thereof and large diameter portions at respective opposite end portions thereof. The pilot piston 112 and the spool driving member 114 are fluid-tightly and slidably fitted in the large diameter portion formed at a back end portion of the housing 110. The opposed piston 118 is fluid-tightly and slidably fitted in the large diameter portion formed at a forward end portion of the housing 110. The spool 116 is slidably fitted in the small diameter portion at the intermediate portion of the housing 110. A spring 119 is provided between the opposed piston 118 and the spool 116.

A space formed at the rear of the pilot piston 112 is a pilot pressure chamber 120 to which the pressure chamber 42 is connected via a pilot passage 122 and a master pressure port 123. Hydraulic pressure in the pressure chamber 42 (which may be hereinafter referred to as “pilot pressure”) is supplied to the pilot pressure chamber 120. A space formed at the rear of the spool driving member 114, i.e., between the pilot piston 112 and the spool driving member 114 is an input chamber 124. The linear valve device 94 is connected to the input chamber 124. Also, the brake cylinders 12RL, 12RR provided for the respective rear left and right wheels 8RL, 8RR are connected to the input chamber 124 via a rear-wheel brake passage 144.

Hydraulic pressure in the pilot pressure chamber 120 acts on a rear end face of the pilot piston 112. Hydraulic pressure in the input chamber 124 acts on a front end face of the pilot piston 112. When the pilot pressure and the hydraulic pressure in the input chamber 124 are generally equal to each other, the pilot piston 112 is kept at its back end position.

The stepped spool driving member 114 includes a large diameter portion 114a and a small diameter portion 114b. A rear end face of the large diameter portion 114a serves as a pressure receiving face which receives the hydraulic pressure in the input chamber 124. The small diameter portion 114b serves as an engaging portion which is engaged with or fitted in an elongated hole 127 formed in the spool 116.

Since the large diameter portion 114a receives the hydraulic pressure in the input chamber 124, a large force related to the hydraulic pressure in the input chamber 124 can be satisfactorily transmitted to the spool 116. Also, the large pressure receiving area reduces a change in a force acting on the spool driving member 114 due to a flow of the working fluid into and out of the input chamber 124, enabling stable transmission of a force related to the hydraulic pressure in the input chamber 124, to the spool 116. Parameters such as the length and the diameter of the elongated hole 127 and the length and the diameter of the small diameter portion 114b, i.e., the engaging portion, are designed so as to reduce inclination of the spool driving member 114 with respect to the spool 116. A distal end portion of the spool driving member 114 has an “R” shape, whereby the centers of the spool driving member 114 and the spool 116 can be precisely aligned.

If the rear end portion of the spool 116 has a large diameter, there is a small need for providing the spool driving member 114 separately. However, in the case where the rear end portion of the spool 116 has a large diameter (that is, the spool 116 and the spool driving member 114 are provided integrally with each other), highly-precise working is made difficult, which makes it difficult to concentrically assemble the spool driving member 114 and the spool 116 to each other. In contrast, by providing the spool 116 and the spool driving member 114 independently of each other, precision of working is improved, thereby facilitating the assembly of the spool 116 and the spool driving member 114.

A portion of the housing 110 which corresponds to a small diameter portion of the cylinder bore has a plurality of ports 130-136 which are spaced apart from each other. Each of the ports 130, 136 serves as a low pressure port which communicates with the master reservoir 82. The port 134 serves as a high pressure port connected to the high pressure source 90. The port 132 serves as an output port which outputs output hydraulic pressure (which may be referred to as “control pressure”) as hydraulic pressure regulated by the regulator 92. The output port 132 is connected to the rear chamber 50 of the master cylinder 26 by an output passage 138. The output hydraulic pressure output from the output port 132 is detected by an output hydraulic sensor 140.

An outer circumferential portion of the spool 116 has two annular grooves 116a, 116b which are spaced apart from each other in the direction of the axis L. That is, the grooves 116a, 116b are respectively formed on opposite sides of a land in the axial direction so as to extend in the axial direction. Movement of the spool 116 in the direction of the axis L causes each of the grooves 116a, 116b to be opposed to and not to be opposed to (spaced apart from) the high pressure port 134 and the low pressure port 130. As a result, the output port 132 selectively communicates with one of the high pressure port 134 and the low pressure port 130 to control hydraulic pressure in the output port 132.

The opposed piston 118 includes a large diameter portion 118a and a small diameter portion 118b. The hydraulic pressure in the output port 132 acts on a front end face of the large diameter portion 118a, and the small diameter portion 118b is opposed to the spool 116. Hydraulic pressure in the low pressure port 136 acts on a step of the large diameter portion 118a and the small diameter portion 118b.

When the hydraulic pressure in the input chamber 124 is increased in the regulator 92, the spool driving member 114 is moved forward, which advances the spool 116. The forward movement of the spool 116 causes the output port 132 to be isolated from the low pressure port 130 and fluidically coupled with the high pressure port 134, resulting in increase in the hydraulic pressure in the output port 132. The force related to the hydraulic pressure in the input chamber 124 (i.e., a value obtained by multiplying input hydraulic pressure by the area Sa of the pressure receiving face of the large diameter portion 114a of the spool driving member 114) is applied to the spool 116 in the forward direction via the spool driving member 114. A force related to the hydraulic pressure in the output port 132 (i.e., a value obtained by multiplying the output hydraulic pressure by the area Sb of a pressure receiving face of the large diameter portion 118a of the opposed piston 118, i.e., the cross-sectional area of the cylinder bore) is applied to the spool 116 in the backward direction via components including the opposed piston 118. The spool 116 is moved to a position at which a force related to the input hydraulic pressure and a force related to the output hydraulic pressure are balanced with each other, so that the output hydraulic pressure is controlled to a value which is determined based on the input hydraulic pressure.

It is noted that in the case where the area Sa and the area Sb are generally equal to each other, the output hydraulic pressure is controlled so as to be equal in magnitude to the input hydraulic pressure.

In case where the input chamber 124 communicates with the master reservoir 82 due to a failure in an electrical system, the pilot piston 112 is moved forward by the pilot pressure (i.e., the hydraulic pressure in the pressure chamber 42). The forward movement of the pilot piston 112 moves the spool 116 forward via the spool driving member 114. The hydraulic pressure in the output port 132 is increased in a state in which working fluid is stored at high hydraulic pressure in the accumulator 98 of the high pressure source 90. A forward force related to the pilot pressure (i.e., a force obtained by multiplying the hydraulic pressure in the pressure chamber 42 by the area Sp of the rear end face of the pilot piston 112) and a backward force related to the output hydraulic pressure are applied to the spool 116.

In the case where the area Sp and the area Sb are generally equal to each other, the output hydraulic pressure is controlled so as to be generally equal in magnitude to the hydraulic pressure in the pressure chamber 42.

Linear Valve Device

The linear valve device 94 includes: a pressure-increase linear valve 150 provided between the high pressure source 90 and the input chamber 124; and a pressure-reduction linear valve 152 provided between the input chamber 124 and the master reservoir 82. The pressure-increase linear valve 150 is a normally closed electromagnetic valve, and the pressure-reduction linear valve 152 is a normally open electromagnetic valve. The hydraulic pressure in the input chamber 124 is controlled by continuous control of currents supplied to respective coils of the pressure-increase linear valve 150 and the pressure-reduction linear valve 152. Increase in the input hydraulic pressure is controlled by the control of the current supplied to the coil of the pressure-increase linear valve 150 in a closed state of the pressure-reduction linear valve 152. Reduction of the input hydraulic pressure is controlled by the control of the current supplied to the coil of the pressure-reduction linear valve 152 in a closed state of the pressure-increase linear valve 150.

Slip Control Device

The front-wheel brake cylinders 6 are connected to the master cylinder 26, and the rear-wheel brake cylinders 12 are connected to the regulator 92 as described above. That is, the hydraulic brake system has front and rear lines in the present embodiment.

The slip control device 16 individually controls the hydraulic pressure in each of the brake cylinders 6FL, 6FR, 12RL, 12RR such that a slip state of a corresponding one of the wheels 2FL, 2FR, 8RL, 8RR is within an appropriate range determined by a coefficient of friction of a road surface. The slip control device 16 includes: a front-wheel slip control device 16F provided on a front-wheel side; and a rear-wheel slip control device 16R provided on a rear-wheel side.

The front-wheel slip control device 16F is connected to the pressure chamber 42, the brake cylinders 6FL, 6FR of the respective front left and right wheels 2FL, 2FR, and a pressure-reduction reservoir 200F. The front-wheel slip control device 16F includes: pressure increase valves 202FL, 202FR provided between the pressure chamber 42 and the respective front-wheel brake cylinders 6FL, 6FR; pressure reduction valves 204FL, 204FR provided between the respective front-wheel brake cylinders 6FL, 6FR and the pressure-reduction reservoir 200F; and a front-wheel pump 210F provided in a pump passage 208F which connects between the pressure-reduction reservoir 200F and a portion 206F of the front-wheel brake passage 60 which is located upstream of the pressure increase valves 202FL, 202FR (this portion 206 may be hereinafter referred to as “ejection portion 206”).

The rear-wheel slip control device 16R is connected to the input chamber 124, the brake cylinders 6RL, 6RR of the respective rear left and right wheels 8RL, 8RR, and a pressure-reduction reservoir 200R. Like the front-wheel slip control device 16F, the rear-wheel slip control device 16R includes pressure increase valves 202RL, 202RR, pressure reduction valves 204RL, 204RR, and a rear-wheel pump 210R. The front-wheel pump 210F and the rear-wheel pump 210R are driven by the same motor, namely, a downstream motor 212.

Brake ECU

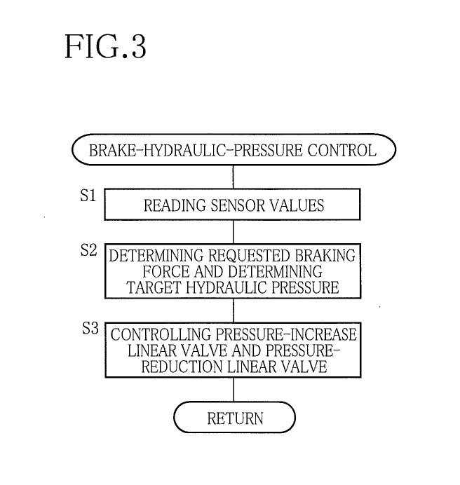

As illustrated in FIG. 2, the brake ECU 20 is constituted mainly by a computer including an executing device 230, a storage device 232, and an input/output device 234. Devices connected to the input/output device 234 include: the reaction force sensor 78; the accumulator pressure sensor 100; the output hydraulic sensor 140; a stroke sensor 240 configured to detect a stroke of the brake pedal 24 (hereinafter may be referred to as “operating stroke”); a foot power sensor 242 configured to detect foot power applied to the brake pedal 24; the linear valve device 94; the outside communication valve 72; the reservoir cut-off valve 84; the hydraulic accumulation motor 97; the downstream motor 212; the pressure increase valves 202; and the pressure reduction valves 204. The storage device 232 stores, for example, a brake-hydraulic-pressure control program illustrated in the flow chart in FIG. 3.

### Operations of Hydraulic Brake System

In the case Where System Operates Normally

In Normal Braking

The outside communication valve 72 is open, and the reservoir cut-off valve 84 is closed. The separated chamber 52 and the annular chamber 44 communicate with the outside passage 68, are isolated from the master reservoir 82, and communicate with the stroke simulator 76.

In the master cylinder 26, the input piston 34 is moved forward by forward movement of the brake pedal 24, which actuates the stroke simulator 76. The pressurizing piston 32 has a pressure receiving face for receiving the hydraulic pressure in the separated chamber 52 of the rear small-diameter portion 40 and a pressure receiving face for receiving the hydraulic pressure in the annular chamber 44 of the intermediate piston portion 38, and the areas of these respective pressure receiving faces are generally equal to each other. The hydraulic pressure in the separated chamber 52 is generally equal to the hydraulic pressure in the annular chamber 44. Accordingly, the pressurizing piston 32 is principally never moved by hydraulic pressure related to the foot power applied to the brake pedal 24 (i.e., the hydraulic pressure in the separated chamber 52).

When the hydraulic pressure in the input chamber 124 is increased in the regulator 92, the spool driving member 114 is moved forward, which advances the spool 116. This increases the hydraulic pressure in the output port 132 to supply the output hydraulic pressure to the rear chamber 50. In the master cylinder 26, hydraulic pressure in the rear chamber 50 moves the pressurizing piston 32 forward, thereby producing hydraulic pressure in the pressure chamber 42 with a magnitude related to the hydraulic pressure in the rear chamber 50. The hydraulic pressure in the pressure chamber 42 is supplied to the front-wheel brake cylinders 6, whereby the hydraulic brakes 4 are actuated to restrain rotation of the front wheels 2.

The hydraulic pressure in the input chamber 124 is supplied to the rear-wheel brake cylinders 12, whereby the hydraulic brakes 10 are actuated to restrain rotation of the rear wheels 8.

It is noted that the hydraulic pressure in the pressure chamber 42 and the hydraulic pressure in the rear chamber 50 have a relationship determined by, e.g. a structure of the master cylinder 26, and the master cylinder 26 can be designed such that the hydraulic pressure in the pressure chamber 42 and the hydraulic pressure in the rear chamber 50 are generally equal to each other in magnitude. Also, in the case where the output hydraulic pressure and the input hydraulic pressure are controlled so as to be equal to each other in magnitude, the hydraulic pressure in the rear chamber 50 (i.e., the output hydraulic pressure), the hydraulic pressure in the pressure chamber 42, the hydraulic pressure in the input chamber 124 are generally equal to each other in magnitude, and the hydraulic pressure in the front-wheel brake cylinders 6 and the hydraulic pressure in the rear-wheel brake cylinders 12 are generally equal to each other in magnitude.

The linear valve device 94 uses the hydraulic pressure in the accumulator 98 to control the input hydraulic pressure, thereby controlling the hydraulic pressure in the brake cylinders 6, 12. The brake-hydraulic-pressure control program illustrated in the flow chart in FIG. 3 is executed each time when a predetermined length of time passes.

This brake-hydraulic-pressure control program is initiated with S1 at which values of the foot power sensor 242, the stroke sensor 240, and other similar devices are obtained, and a braking operation state is obtained. The braking operation state is a state of driver's operation on the brake pedal 24. At S2, a requested braking force, which is a braking force requested by the driver, is obtained based on the braking operation state, and target hydraulic pressure for each of the brake cylinders 6, 12 is determined. Feedback control is at S3 executed for the linear valve device 94 to bring a detection value of the output hydraulic sensor 140 closer to the target hydraulic pressure. It is noted that the output hydraulic pressure is equal to the input hydraulic pressure.

For example, in the case where regenerative braking is not performed (examples of this case include: the case where the hydraulic brake system is installed on a vehicle not including an electric motor as a drive source; and the case where regenerative braking is not performed due to a situation of the system, for example), the target hydraulic pressure for each of the brake cylinders 6, 12 is determined at a magnitude that enables the requested braking force to be achieved by an operation of a corresponding one of the hydraulic brakes 4, 10. In the case where regenerative braking is performed (in the case where regenerative cooperative control is executed), the target hydraulic pressure for each of the brake cylinders 6, 12 is obtained based on the requested braking force and a regenerative braking force. That is, the target hydraulic pressure is determined such that the requested braking force is produced by the regenerative braking force and the hydraulic braking force produced by the operation of each hydraulic brake.

Thus, regardless of whether the regenerative cooperative control is executed or not, the target hydraulic pressure for each of the brake cylinders 6, 12 is determined, in normal braking, based on the requested braking force intended by the driver.

Incidentally, the stiffness of the working fluid in the input chamber 124 is large (noted that the stiffness is obtained by dividing an amount of change in hydraulic pressure by an amount of change in an amount of the working fluid). Thus, an amount of change in the hydraulic pressure in the input chamber 124 is large when the working fluid flows into and out of the input chamber 124 at a high rate in the case where the rear-wheel brake cylinders 12 are not connected to the input chamber 124. In particular, since a difference between the accumulator pressure and the hydraulic pressure in the input chamber 124 is large at a start of pressure increase (noted that the hydraulic pressure in the input chamber 124 is substantially equal to the atmospheric pressure), the working fluid is supplied to the input chamber 124 at a high flow rate, resulting in rapid increase in the hydraulic pressure in the input chamber 124. This makes it difficult to bring an actual hydraulic pressure closer to the target hydraulic pressure.

In the present embodiment, in contrast, the brake cylinders 12RL, 12RR of the respective rear wheels 8 are connected to the input chamber 124, resulting in lower stiffness of the working fluid in the input chamber 124. This construction can reduce the rapid increase in the hydraulic pressure in the input chamber 124 at the start of the pressure increase, enabling the hydraulic pressure to be satisfactorily brought closer to the target hydraulic pressure. Also, each of the brake cylinders 12 has a function of a damper. Thus, even in the event of vibrations of the hydraulic pressure in the input chamber 124, such vibrations can be satisfactorily reduced, improving controllability.

At a release of the hydraulic brakes 10, the hydraulic pressure in the rear-wheel brake cylinders 12 is returned to the master reservoir 82 via the pressure-reduction linear valve 152 and the reservoir passage 80.

In Slip Control

In the event of a large amount of slip of the front wheels 2FL, 2FR and the rear wheels 8RL, 8RR, the hydraulic pressure in each of the brake cylinders 6FL, 6FR, 12RL, 12RR is controlled by control of opening and closing of a corresponding one of the pressure increase valves 202FL, 202FR, 202RL, 202RR and a corresponding one of the pressure reduction valves 204FL, 204FR, 204RL, 204RR. As a result, a slip state of each of the front wheels 2FL, 2FR and the rear wheels 8RL, 8RR is changed to a state that is within an appropriate range with respect to a coefficient of friction of a road surface.

In the event of Malfunction in Electrical System

The electromagnetic valves are kept at their respective original positions illustrated in FIG. 1.

In the master cylinder 26, the separated chamber 52 is isolated from the annular chamber 44 and sealed off, and the annular chamber 44 communicates with the master reservoir 82. The rear chamber 50 communicates with the master reservoir 82 via the regulator 92. When the brake pedal 24 is depressed, the input piston 34 is moved forward, which advances the pressurizing piston 32 in a state in which the volume of the separated chamber 52 is kept constant, thereby producing hydraulic pressure in the pressure chamber 42. In other words, the pressurizing piston 32 is moved forward by the operation on the brake pedal 24. This operation of the master cylinder 26 may be hereinafter referred to as “manual operation”, and the hydraulic pressure produced in the pressure chamber 42 as “manual pressure”.

Also, as illustrated in FIG. 1, in the case where the cross-sectional area B of the rear small-diameter portion 40 of the pressurizing piston 32 is larger than the cross-sectional area A of the input piston 34, the stroke of the pressurizing piston 32 can be reduced when compared with the stroke of the input piston 34. Accordingly, increase in the stroke of the pressurizing piston 32 and the like can be reduced in the event of malfunction, thereby shortening the entire length of the master cylinder 26.

The input chamber 124 formed in the regulator 92 communicates with the master reservoir 82. When hydraulic pressure is produced in the pressure chamber 42 by the manual operation of the master cylinder 26 and supplied to the pilot pressure chamber 120 of the regulator 92, the pilot piston 112 is moved forward and brought into contact with the spool driving member 114. The spool driving member 114 is thereby moved forward, which advances the spool 116. As a result, the output port 132 communicates with the high pressure port 134, which increases the hydraulic pressure in the output port 132 in the case where hydraulic pressure remains in the accumulator 98. The hydraulic pressure in the output port 132 is supplied to the rear chamber 50, which applies an assisting force to the pressurizing piston 32. This assisting force makes the hydraulic pressure in the pressure chamber 42 larger than the manual pressure, resulting in increase in the hydraulic pressure in the front-wheel brake cylinders 6.

It is noted that in the case where no hydraulic pressure is stored in the accumulator 98, the working fluid is supplied from the master reservoir 82 to the rear chamber 50 via a suction valve and a discharge valve (not shown) of the hydraulic accumulation pump 96, making it difficult for the hydraulic pressure in the rear chamber 50 to become a negative pressure.

Since the rear-wheel brake cylinders 12 communicate with the master reservoir 82 via the normally open pressure-reduction linear valve 152, no hydraulic pressure is produced in the event of malfunction in the electrical system.

In the present embodiment as described above, an input-hydraulic-pressure control device is constituted by the linear valve device 94 and portions of the brake ECU 20 which store and execute the brake-hydraulic-pressure control program illustrated in the flow chart in FIG. 3, for example, and an electromagnetic valve controller is constituted by portions of the brake ECU 20 which store and execute the processing at S3 in the brake-hydraulic-pressure control program. The electromagnetic valve controller also serves as a first brake-cylinder hydraulic controller. It is noted that each of the rear-wheel brake cylinders 12 corresponds to a first brake cylinder, and each of the front-wheel brake cylinders 6 to a second brake cylinder. Each of the pressure-increase linear valve 150 and the pressure-reduction linear valve 152 corresponds to an electromagnetic valve.

The regulator may have any construction. For example, the regulator may include a poppet valve. The master cylinder may also have any construction. For example, the pressurizing piston may be constituted by two or more components.

In FIG. 1, the ports formed in the housing 110 of the regulator 92 are illustrated so as to be open to the atmosphere, but these ports are closed in reality and not open to the atmosphere. This applies to the other figures.

### Second Embodiment

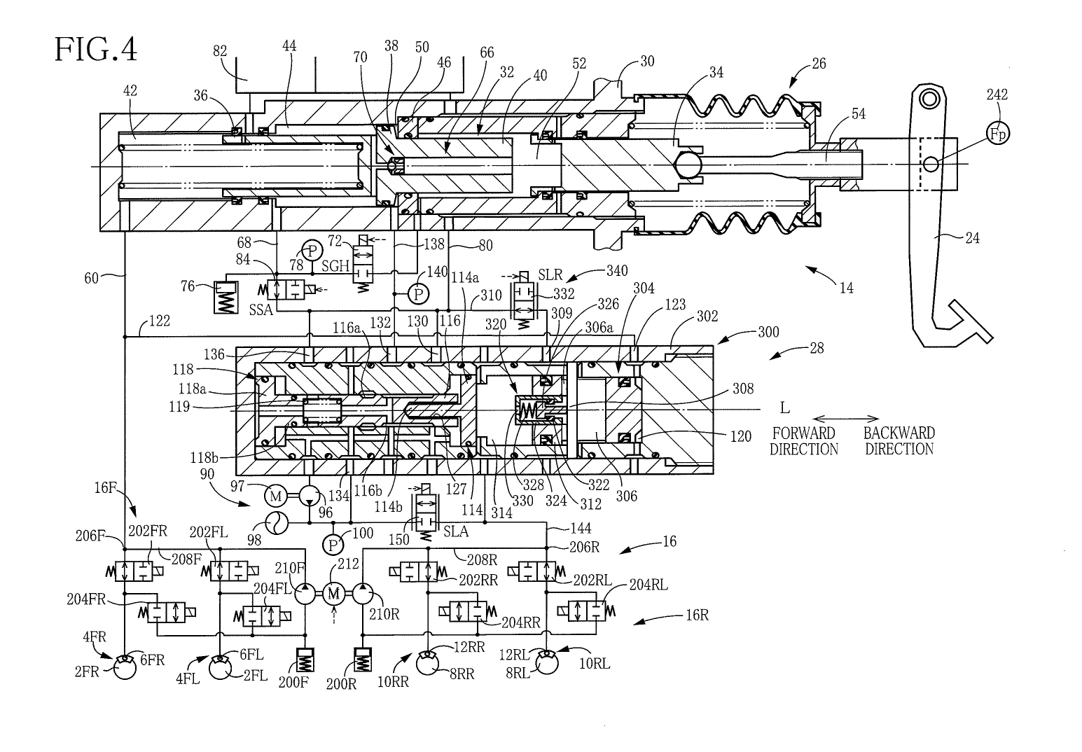

FIG. 4 illustrates a hydraulic brake system according to a second embodiment. The hydraulic brake system illustrated in FIG. 4 differs from the hydraulic brake system according to the first embodiment in, e.g., a construction of the regulator. It is noted that the same reference numerals as used in the first embodiment are used to designate the corresponding elements in FIG. 4, and an explanation and drawings of which are dispensed with.

### Configuration

A regulator 300 includes a pilot piston 304, the spool driving member 114, the spool 116, and the opposed piston 118 provided in a cylinder bore formed in a housing 302. The pilot piston 304, the spool driving member 114, the spool 116, and the opposed piston 118 are arranged in the direction parallel with the axis L so as to be slidable in this direction.

The pilot piston 304 has a fitting groove 306 formed through the pilot piston 304 in its radial direction and extending in the direction of the axis L. A rod 308 fixed to the housing 302 and extending in the radial direction is fitted in the fitting groove 306 such that the rod 308 and the fitting groove 306 are movable relative to each other. A low pressure chamber 306a formed by the fitting groove 306 and the housing 302 is connected to the master reservoir 82 via a low pressure port 309 and a reservoir passage 310.

In a front portion of a main body 312 of the pilot piston 304, a mechanical cut-off valve 320 is provided, as an interrupting mechanism, between an input chamber 314 and the low pressure chamber 306a. The cut-off valve 320 includes: a valve housing 324 fixed to the main body 312 of the pilot piston 304; a valve seat 322 provided on the valve housing 324; a valve member 326 movable toward and away from the valve seat 322; and a spring 328 which applies an elastic force in a direction in which the valve member 326 is seated on the valve seat 322. The valve housing 324 has an opening portion 330 which is open in the input chamber 314.

The rod 308 is brought into contact with the valve member 326 at a back end position of the pilot piston 304, whereby the valve member 326 is moved off the valve seat 322 against an elastic force of the spring 328, that is, the cut-off valve 320 is opened. In this state, the input chamber 314 communicates with the low pressure chamber 306a. When the pilot piston 304 is moved forward, the valve member 326 is moved off the rod 308 and seated on the valve seat 322 by the elastic force of the spring 328, that is, the cut-off valve 320 is closed. In this state, the input chamber 314 is isolated from the low pressure chamber 306a.

A pressure-reduction linear valve 332 as a normally open electromagnetic valve is provided in the reservoir passage 310. The pressure-reduction linear valve 332 corresponds to the pressure-reduction linear valve 152 in the first embodiment and reduces hydraulic pressure in the input chamber 314 by control of a current I supplied to a coil of the pressure-reduction linear valve 332 in the open state of the cut-off valve 320.

### Operations

In the Case Where System Operates Normally

The pilot piston 304 is located its back end position in the regulator 300. Thus, the cut-off valve 320 is in the open state, and the input chamber 314 is communicable with the master reservoir 82 via the cut-off valve 320, the low pressure chamber 306a, and the pressure-reduction linear valve 332. The hydraulic pressure in the input chamber 314 is controlled by control of currents supplied to respective coils of the pressure-increase linear valve 150 and the pressure-reduction linear valve 332. The control of the hydraulic pressure in the input chamber 314 controls the output hydraulic pressure such that the output hydraulic pressure is supplied to the rear chamber 50 to move the pressurizing piston 32 forward. The hydraulic pressure in the pressure chamber 42 is supplied to the front-wheel brake cylinders 6. The hydraulic pressure in the input chamber 314 is supplied to the rear-wheel brake cylinders 12.

In the Event of Malfunction in Electrical System

In the event of malfunction in the electrical system, the pilot piston 304 is moved forward by the pilot pressure (i.e., the hydraulic pressure in the pressure chamber 42) in the regulator 300. The cut-off valve 320 is closed, and thereby the input chamber 314 is isolated from the master reservoir 82. The hydraulic pressure in the input chamber 314 is increased by the forward movement of the pilot piston 304 and supplied to the rear-wheel brake cylinders 12, thereby actuating the hydraulic brakes 10. In these operations, the hydraulic pressure in the input chamber 314 is made equal to the pilot pressure in magnitude. Thus, hydraulic pressure equal to the hydraulic pressure in the pressure chamber 42 in magnitude can be supplied to the rear-wheel brake cylinders 12.

The increase in the hydraulic pressure in the input chamber 314 moves the spool driving member 114 forward, which advances the spool 116. The output hydraulic pressure in the output port 132 is increased while the hydraulic pressure remains in the accumulator 98. The increased output hydraulic pressure is supplied to the rear chamber 50.

In the master cylinder 26, hydraulic pressure higher than the manual pressure is produced in the pressure chamber 42 and supplied to the front-wheel brake cylinders 6.

Thus, since the regulator 300 uses the pilot pressure to produce hydraulic pressure in the input chamber 314, the hydraulic pressure can be supplied to the rear-wheel brake cylinders 12 connected to the input chamber 314 even in the event of malfunction in the electrical system.

In view of the above, a linear valve device 340 is constituted by devices such as the pressure-reduction linear valve 332 and the pressure-increase linear valve 150 in the present embodiment.

### Third Embodiment

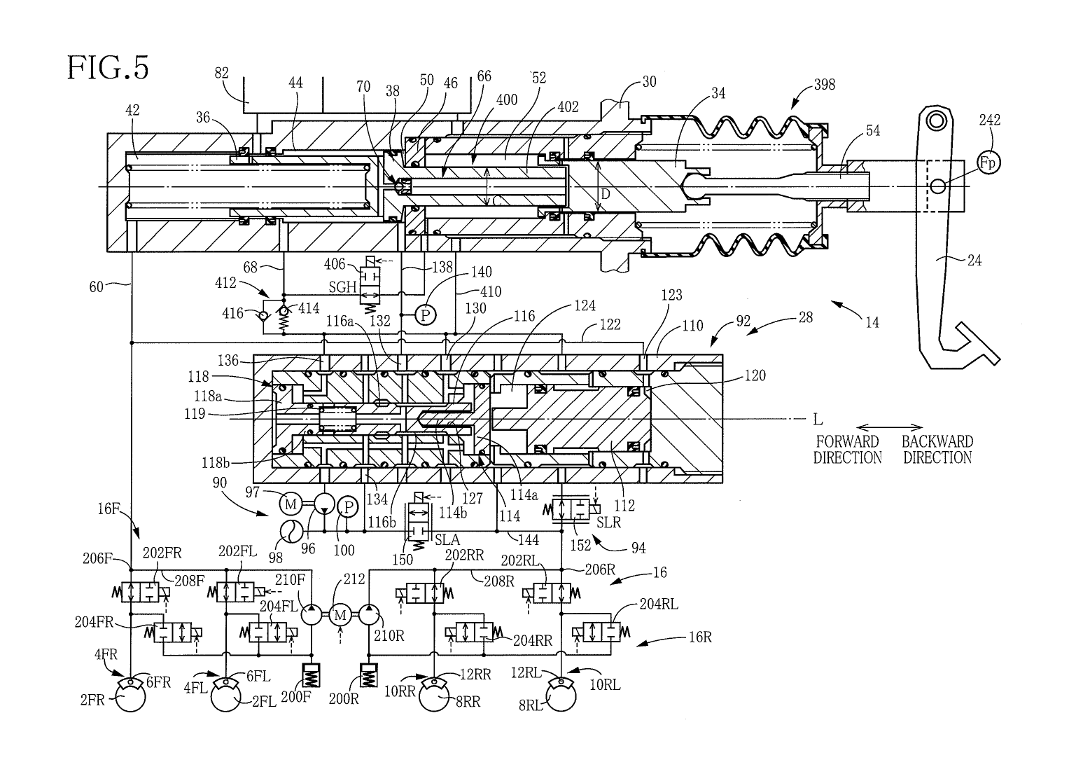

FIG. 5 illustrates a hydraulic brake system according to a third embodiment. The hydraulic brake system illustrated in FIG. 5 differs from the hydraulic brake systems according to the first and second embodiments mainly in the master cylinder. It is noted that the same reference numerals as used in the first embodiment are used to designate the corresponding elements in FIG. 5, and an explanation and drawings of which are dispensed with.

### Configuration

The hydraulic brake system illustrated in FIG. 5 is configured such that the cross-sectional area C of a rear small-diameter portion 402 of a pressurizing piston 400 of a master cylinder 398 is smaller than the cross-sectional area D of the input piston 34. A normally open outside communication valve 406 is provided in the outside passage 68 that connects between the separated chamber 52 and the annular chamber 44. A flow limiting device 412 is provided in a reservoir passage 410 that connects between the master reservoir 82 and a portion of the outside passage 68 which is located on a side of the outside communication valve 406 nearer to the annular chamber 44. The flow limiting device 412 includes a relief valve 414 and a check valve 416 provided in parallel. The relief valve 414 is kept closed while the hydraulic pressure in the annular chamber 44 is lower than relief pressure, i.e., valve opening pressure. When the hydraulic pressure in the annular chamber 44 reaches the valve opening pressure, the relief valve 414 is opened to allow the working fluid to flow from the annular chamber 44 to the master reservoir 82. The check valve 416 is provided to prevent the hydraulic pressure in the annular chamber 44 from becoming a negative pressure. The check valve 416 allows the working fluid to flow from the master reservoir 82 to the annular chamber 44 when hydraulic pressure in the master reservoir 82 exceeds the hydraulic pressure in the annular chamber 44.

### Operations

In the case Where System Operates Normally

The outside communication valve 406 is closed, and thus the separated chamber 52 is sealed off.

When the brake pedal 24 is depressed, the input piston 34 is moved forward in the master cylinder 398, which advances the pressurizing piston 400 in a state in which the volume of the separated chamber 52 is kept constant. Since the cross-sectional area C of the rear small-diameter portion 402 of the pressurizing piston 400 is smaller than the cross-sectional area D of the input piston 34, the stroke of the pressurizing piston 400 is larger than that of the input piston 34. While the hydraulic pressure in the annular chamber 44 is lower than the valve opening pressure of the relief valve 414, the working fluid in the annular chamber 44 is supplied to the separated chamber 52 via the inside passage 66 and the inside communication valve 70, so that the pressurizing piston 400 is moved forward relative to the input piston 34. In view of the above, the pressurizing piston 400 can be stroked longer by the same amount of stroke of the brake pedal 24 when compared with the case where the hydraulic pressure in the annular chamber 44 flows to the master reservoir 82. Accordingly, a larger amount of working fluid can be supplied to the front-wheel brake cylinders 6.

Each brake cylinder is characterized such that the hydraulic pressure therein is considerably low while an amount of fluid supplied to the brake cylinder is smaller than a set amount, but the hydraulic pressure increases with increase in the amount of fluid while the amount of fluid is larger than or equal to the set amount. In the present embodiment, the pressurizing piston 400 can be moved forward by a greater distance in response to depression of the brake pedal 24 at the start of operation of the brake pedal 24, enabling quick supply of the working fluid to the front-wheel brake cylinders 6. This enables quick supply of the working fluid to the front-wheel brake cylinders 6 by an amount larger than or equal to the set amount, resulting in quick completion of first fill. Consequently, the hydraulic pressure in the front-wheel brake cylinders 6 can be quickly increased, resulting in quick actuation of the hydraulic brakes 4. The pressurizing piston 400 can be moved forward to supply the working fluid to the front-wheel brake cylinders 6 before the output hydraulic pressure is supplied from the regulator 92 to the rear chamber 50. This operation can satisfactorily reduce actuation delay in the front wheel brakes 4 which is caused by actuation delay in the regulator 92 due to connection of the rear-wheel brake cylinders 12 to the input chamber 124 of the regulator 92.

It is noted that since the pressurizing piston 400 is moved forward relative to the input piston 34 as described above, the input piston 34 is never brought into contact with the pressurizing piston 400.

When the hydraulic pressure in the annular chamber 44 then reaches the valve opening pressure of the relief valve 414, the relief valve 414 is opened. The pressurizing piston 400 is moved forward with the advance of the input piston 34, but the working fluid in the annular chamber 44 is supplied to the master reservoir 82 via the relief valve 414.

When the output hydraulic pressure is supplied to the rear chamber 50, the pressurizing piston 400 receives a forward force related to the hydraulic pressure in the separated chamber 52 (i.e., a value obtained by multiplying the hydraulic pressure in the separated chamber 52 by the cross-sectional area C) and a forward force related to the hydraulic pressure in the rear chamber 50. The forward movement of the pressurizing piston 400 produces hydraulic pressure in the pressure chamber 42.

In the present embodiment as described above, the forward movement of the brake pedal 24 is allowed without providing the stroke simulator, and a reaction force is applied with respect to the operating force. This construction eliminates the need of the stroke simulator.

In the Event of Malfunction in Electrical System

In the event of malfunction in the electrical system, the outside communication valve 406 is opened, and thus the separated chamber 52 and the annular chamber 44 communicate with each other. While the hydraulic pressure in the annular chamber 44 is lower than the valve opening pressure of the relief valve 414 in the master cylinder 398, the working fluid is supplied from the annular chamber 44 to the separated chamber 52, thereby moving the pressurizing piston 400 forward relative to the input piston 34. When the hydraulic pressure in the annular chamber 44 then exceeds the valve opening pressure of the relief valve 414, forward movement of the brake pedal 24 causes the working fluid to flow from the separated chamber 52 and the annular chamber 44 to the master reservoir 82. The brake pedal 24, the input piston 34, and the pressurizing piston 400 are moved forward together, thereby producing hydraulic pressure in the pressure chamber 42. Also, the pilot piston 112 is moved forward in the regulator 92, whereby the output hydraulic pressure is increased and supplied to the rear chamber 50. As a result, the hydraulic pressure in the front-wheel brake cylinders 6 can be increased. Since the rear-wheel brake cylinders 12 communicate with the master reservoir 82, no hydraulic pressure is produced in the rear-wheel brake cylinders 12.

### Fourth Embodiment

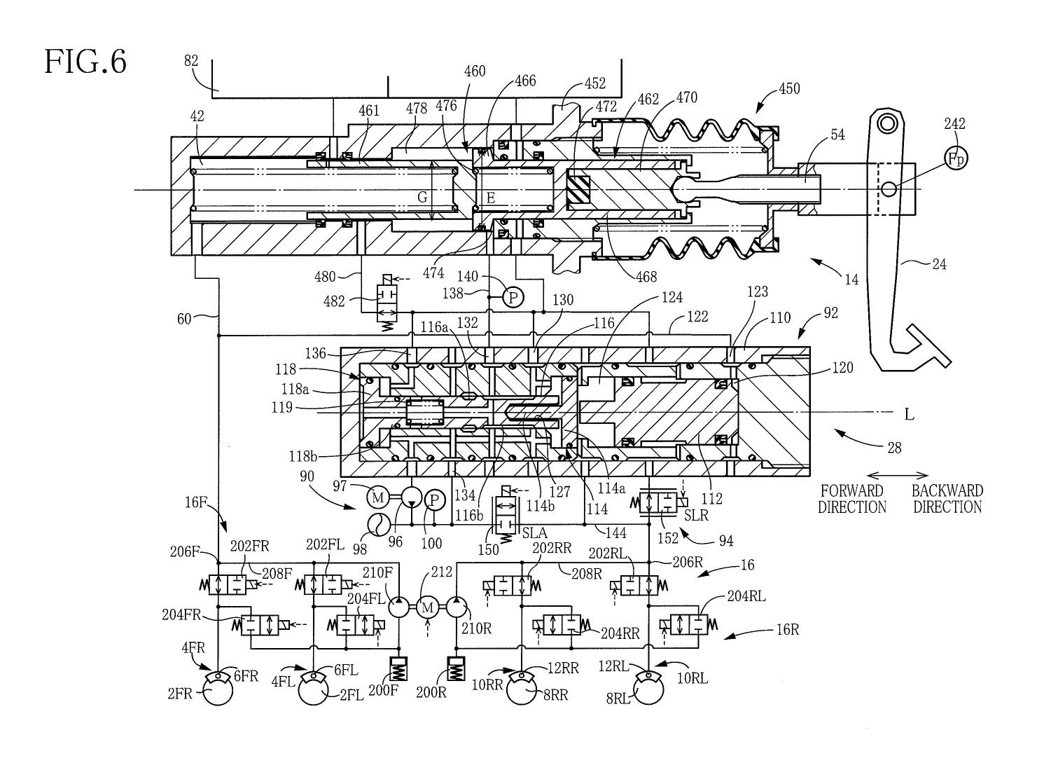

FIG. 6 illustrates a hydraulic brake system according to a fourth embodiment. The hydraulic brake system illustrated in FIG. 6 differs from the hydraulic brake systems according to the first through third embodiments mainly in the master cylinder. It is noted that the same reference numerals as used in the first through third embodiments are used to designate the corresponding elements in FIG. 6, and an explanation and drawings of which are dispensed with.

### Configuration

The hydraulic brake system illustrated in FIG. 6 is configured such that a pressurizing piston 460 is fluid-tightly and slidably fitted in a housing 452 of a master cylinder 450. The pressurizing piston 460 includes a front piston 461 and an intermediate piston 462 which are movable relative to each other. The pressure chamber 42 is formed in front of the front piston 461. The intermediate piston 462 is a stepped piston which includes a large-diameter piston portion 466 provided at a front portion thereof and a small diameter portion 468 provided at a rear portion thereof. An input transmitting member 470 is fitted in a rear end portion of the intermediate piston 462 via an elastic member 472. The brake pedal 24 is coupled to the input transmitting member 470 by the operating rod 54. The large-diameter piston portion 466 and the small diameter portion 468 are fluid-tightly and slidably fitted in the housing 452, and a rear chamber 474 is defined at a rear of the large-diameter piston portion 466.

A spring 476 is provided between the intermediate piston 462 and the front piston 461 to limit a distance of separation between the intermediate piston 462 and the front piston 461. An intermediate chamber 478 is formed between the intermediate piston 462 and the front piston 461. The intermediate chamber 478 includes: an annular portion formed in front of the large-diameter piston portion 466; and a rear portion formed at the rear of the front piston 461. The intermediate chamber 478 is connected to the master reservoir 82 by a reservoir passage 480. A normally open reservoir cut-off valve 482 is provided in the reservoir passage 480.

It is noted that the stroke simulator is not necessary also in the present embodiment.

### Operations

In the Case Where System Operates Normally

The reservoir cut-off valve 482 is closed, and the intermediate chamber 478 is sealed off. When the brake pedal 24 is depressed, the intermediate piston 462 is moved forward via the input transmitting member 470. The front piston 461 is moved forward relative to the intermediate piston 462 in a state in which the volume of the intermediate chamber 478 is kept constant. The intermediate piston 462 receives a forward force Fh related to the hydraulic pressure in the rear chamber 474 (i.e., a force obtained by multiplying the hydraulic pressure in the rear chamber 474 by the area of a facing face of the large-diameter piston portion 466 which faces the rear chamber 474 formed at the rear of the large-diameter piston portion 466) and a braking operation force Fp applied via the input transmitting member 470. Hydraulic pressure related to the sum of the forward forces Fp, Fh, namely, a force F, is produced in the pressure chamber 42 and the intermediate chamber 478. As a result, the hydraulic pressure in the pressure chamber 42 and the hydraulic pressure in the intermediate chamber 478 become equal to each other in magnitude. The hydraulic pressure Pm in the pressure chamber 42 has a magnitude obtained by dividing the total forward force F by the area E of a facing face of the large-diameter piston portion 466 which faces the intermediate chamber 478 (Pm=F/E).

In the Event of Malfunction in Electrical System

The reservoir cut-off valve 482 is opened, and the intermediate chamber 478 communicates with the master reservoir 82. The input transmitting member 470, the intermediate piston 462, and the front piston 461 are moved together, and depression of the brake pedal 24 moves the pressurizing piston 460 forward. The intermediate piston 462 receives the braking operation force Fp and the forward force Fh related to the hydraulic pressure in the rear chamber 474 (in the case where the output hydraulic pressure is supplied to the rear chamber 474). As a result, the hydraulic pressure Pm in the pressure chamber 42 has a magnitude obtained by dividing the forward force applied to the intermediate piston 462 (F=Fp or F=Fp+Fh) by the area G of a facing face of the front piston 461 which faces the pressure chamber 42 (Pm=F/G).

Thus, the area for pressurizing the hydraulic pressure in the pressure chamber 42 of the pressurizing piston 460 is the area E in the normal state of the system and is the area G smaller than the area E in the event of malfunction of the electrical system (G<E). The hydraulic pressure in the pressure chamber 42 is pressurized by the larger area in the normal state of the system, thereby shortening the stroke of the brake pedal 24 in the case where the same amount of working fluid is supplied to the brake cylinders 6. In the event of malfunction in the electrical system, the hydraulic pressure in the pressure chamber 42 is pressurized by the smaller area, enabling increase in the hydraulic pressure in the pressure chamber 42 in the case where the same forward force is applied to the pressurizing piston 460, thereby making this hydraulic brake system more fail-safe.

### Fifth Embodiment

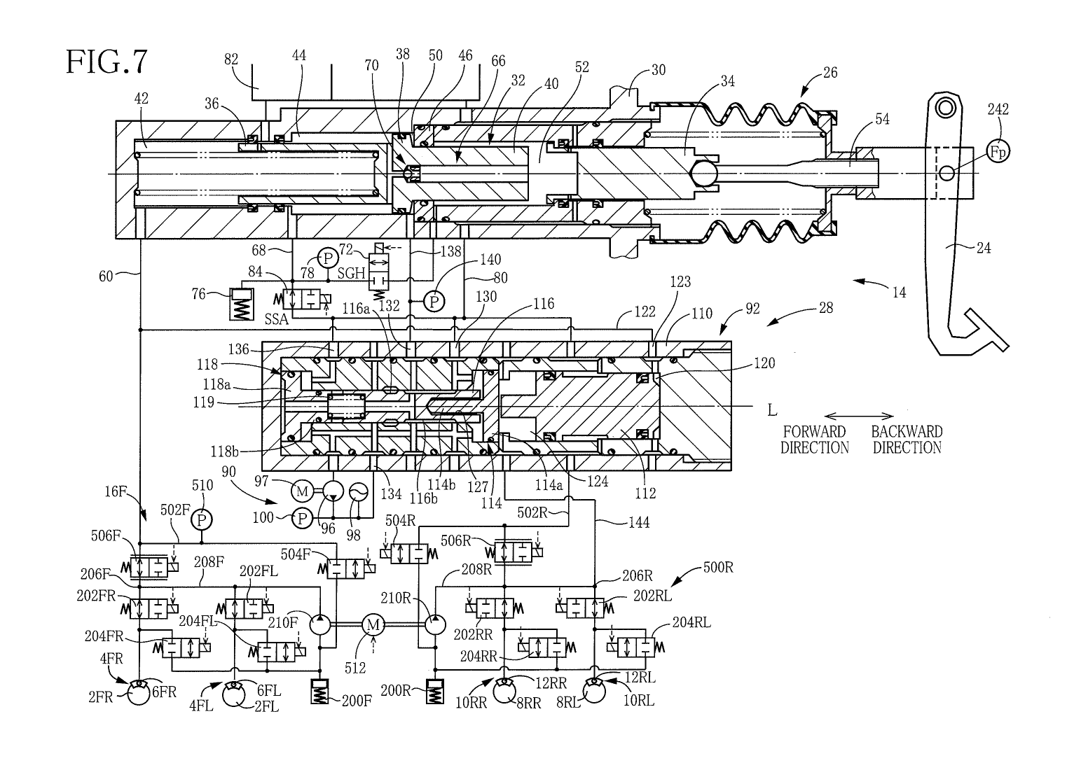

FIG. 7 illustrates a hydraulic brake system according to a fifth embodiment. The hydraulic brake system illustrated in FIG. 7 differs from the hydraulic brake systems according to the first through fourth embodiments mainly in the input-hydraulic-pressure control device and the slip control device. It is noted that the same reference numerals as used in the first through fourth embodiments are used to designate the corresponding elements in FIGS. 7-11, and an explanation and drawings of which are dispensed with.

### Configuration

In the hydraulic brake system illustrated in FIG. 7, a slip control device 500 includes a front-wheel slip control device 500F and a rear-wheel slip control device 500R.

The rear-wheel slip control device 500R is connected to the rear-wheel brake cylinders 12RL, 12RR, the input chamber 124, and the pressure-reduction reservoir 200R. The rear-wheel slip control device 500R includes: the pressure increase valves 202RL, 202RR; the pressure reduction valves 204RL, 204RR; the rear-wheel pump 210R; a replenishment passage 502R which connects the master reservoir 82 and a suction side of the rear-wheel pump 210R; a replenishment valve 504R provided in the replenishment passage 502R; and a rear-wheel linear valve 506R provided between the pump passage 208R (a discharge side of the rear-wheel pump 210R) and the master reservoir 82. The rear-wheel linear valve 506R may be provided between a pump passage 208R and the replenishment passage 502R.

The front-wheel slip control device 500F and the rear-wheel slip control device 500R are similar in construction but different from each other in that a replenishment passage 502F is provided in a state in which the replenishment passage 502F connects between the pressure chamber 42 and a suction-side of the front-wheel pump 210F and that a front-wheel linear valve 506F is provided upstream of an ejection portion 206F of the front-wheel brake passage 60. A master-cylinder-pressure sensor 510 is provided at a portion of the replenishment passage 502F which is located on a side of a replenishment valve 504F nearer to the front-wheel brake passage 60. This master-cylinder-pressure sensor 510 detects the hydraulic pressure in the pressure chamber 42. The same numbers as used in the rear-wheel slip control device 500R are used to designate corresponding components of the front-wheel slip control device 500F, except for the suffix F being added to the corresponding numbers of the components of the front-wheel slip control device 500F, and an explanation of which is dispensed with.

It is noted that the rear-wheel pump 210R and the front-wheel pump 210F are driven by the same motor, namely, a downstream motor 512.

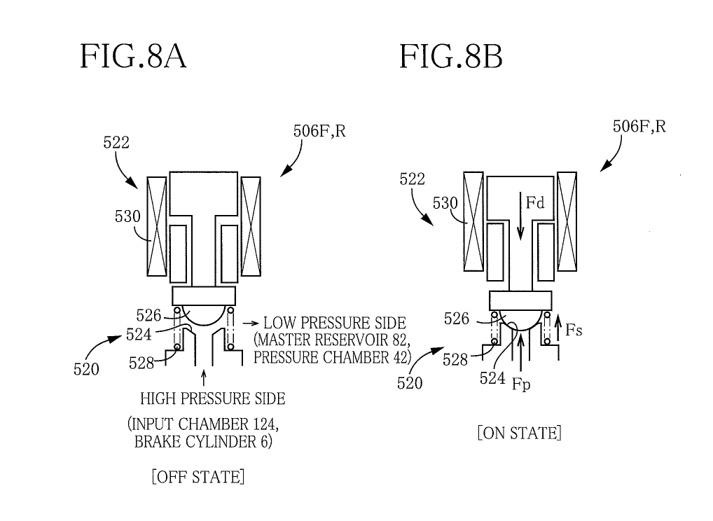

The rear-wheel linear valve 506R and the front-wheel linear valve 506F have the same structure, one example of which is illustrated in FIGS. 8A and 8B.

Each of the rear-wheel linear valve 506R and the front-wheel linear valve 506F includes a poppet valve portion 520 and a solenoid 522. The poppet valve portion 520 includes a valve seat 524, a valve member 526, and a spring 528 which applies an elastic force Fs in a direction in which the valve member 526 is moved away from the valve seat 524. Each of the rear-wheel linear valve 506R and the front-wheel linear valve 506F is kept open while no current is supplied to a coil 530 of the solenoid 522. Each of the rear-wheel linear valve 506R and the front-wheel linear valve 506F is provided in a state in which a pressure differential force Fp related to a pressure differential between a high-pressure side (including the input chamber 124 and the front-wheel brake cylinders 6) and a low-pressure side (including the master reservoir 82 and the pressure chamber 42) acts in a direction in which the valve member 526 is moved away from the valve seat 524. The pressure differential force Fp is obtained by multiplying the pressure differential by the pressure receiving area of the valve member 526. When a current is supplied to the coil 530, an electromagnetic driving force Fd acts in a direction in which the valve member 526 is moved toward the valve seat 524.

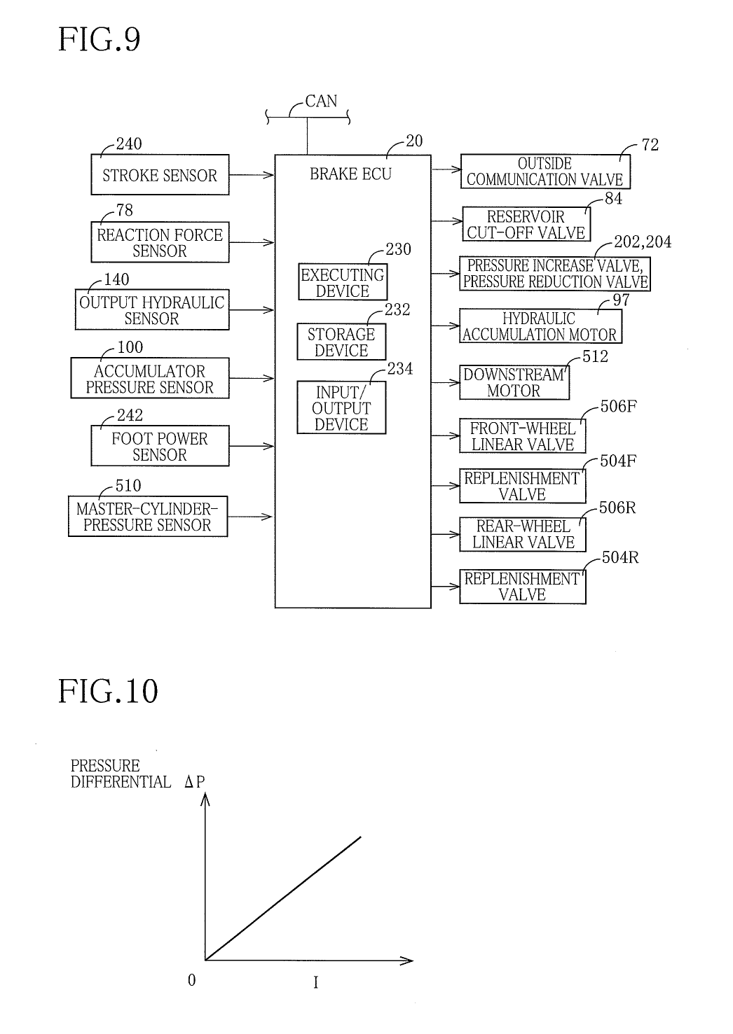

As illustrated in FIG. 10, each of the rear-wheel linear valve 506R and the front-wheel linear valve 506F is capable of increasing the pressure differential between the high-pressure side and the low-pressure side with increase in a current I supplied to the coil 530. Each of the rear-wheel linear valve 506R and the front-wheel linear valve 506F is characterized such that a valve-opening pressure differential is larger in the case where the current I supplied to the coil 530 is large than in the case where the current I supplied to the coil 530 is small. The valve-opening pressure differential is a pressure differential at which the linear valve is switched from its closed state to its open state. FIG. 10 illustrates a table representing a relationship between the valve-opening pressure differential and an amount of the current I supplied to the coil 530. This table is obtained and stored in advance.

In the present embodiment, the current I to be supplied to the coil 530 is determined based on the relationship illustrated in FIG. 10 and a pressure differential which is established in the case where hydraulic pressure on the high-pressure side (i.e., the hydraulic pressure in the input chamber 124 and the hydraulic pressure in the front-wheel brake cylinders 6) is a target value. This pressure differential may be hereinafter referred to as “target pressure differential.”

For example, in the case where the current I is supplied to the coil 530 of the rear-wheel linear valve 506R, the rear-wheel linear valve 506R is kept closed while the hydraulic pressure in the input chamber 124 is low, and the actual pressure differential is lower than the target pressure differential. The working fluid discharged from the rear-wheel pump 210R is supplied to the input chamber 124. When the hydraulic pressure in the input chamber 124 is thereafter increased, and thereby the actual pressure differential reaches the target pressure differential, the rear-wheel linear valve 506R is opened to allow the working fluid to flow from the input chamber 124 to the master reservoir 82. The working fluid discharged from the rear-wheel pump 210R is returned to the suction side via the rear-wheel linear valve 506R and the replenishment valve 504R. The hydraulic pressure in the input chamber 124 is brought closer to the target hydraulic pressure as described above, and feedforward control is executed for the current supplied to the coil 530 of the rear-wheel linear valve 506R.

Also, a current supplied to the downstream motor 512 is controlled based on, e.g., a speed of change in a target value of the hydraulic pressure in the input chamber 124 and a difference between the actual hydraulic pressure and the target value. The supply current is increased in the case where the working fluid is requested to be supplied at a high flow rate.

As illustrated in FIG. 9, devices connected to the input/output device 234 of the brake ECU 20 include the outside communication valve 72, the reservoir cut-off valve 84, the pressure increase valves 202, the pressure reduction valves 204, the hydraulic accumulation motor 97, the downstream motor 512, the rear-wheel linear valve 506R, the front-wheel linear valve 506F, and the replenishment valves 504F, 504R. The storage device 232 stores the table illustrated in FIG. 10, the brake-hydraulic-pressure control program, and other similar information.

### Operations

In the Case Where System Operates Normally

In Normal Braking

In the rear-wheel slip control device 500R, the replenishment valve 504R is opened, and the rear-wheel pump 210R is actuated by driving of the downstream motor 512. In the regulator 92, the hydraulic pressure in the input chamber 124 is controlled by control of the rear-wheel linear valve 506R and the downstream motor 512 using the working fluid discharged from the rear-wheel pump 210R.

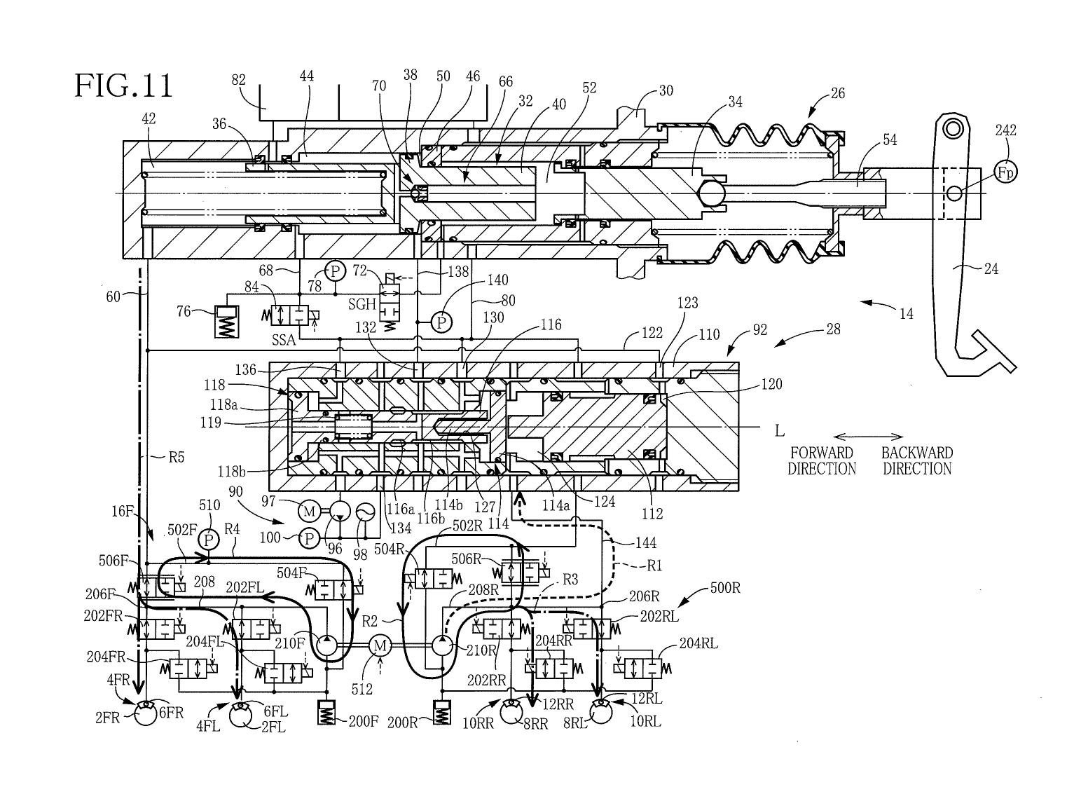

The working fluid discharged from the rear-wheel pump 210R is supplied to the input chamber 124 as indicated by the broken line R1 in FIG. 11 while the rear-wheel linear valve 506R is kept closed. When the rear-wheel linear valve 506R is opened, the working fluid is returned to the suction side of the rear-wheel pump 210R as indicated by the solid line R2. The returned working fluid is sucked and discharged by the rear-wheel pump 210R to circulate the working fluid. The hydraulic pressure in the input chamber 124 is brought closer to the target hydraulic pressure. The regulator 92 is actuated by the hydraulic pressure in the input chamber 124 to supply the output hydraulic pressure to the rear chamber 50. In the master cylinder 26, the pressurizing piston 32 is moved forward to produce hydraulic pressure in the pressure chamber 42. The hydraulic pressure in the pressure chamber 42 is supplied to the front-wheel brake cylinders 6 as indicated by the one-dot chain line R5. The hydraulic pressure in the input chamber 124 is supplied to the rear-wheel brake cylinders 12 as indicated by the one-dot chain line R3. The hydraulic pressure equal in magnitude to the hydraulic pressure in the input chamber 124 is supplied to the rear-wheel brake cylinders 12.

The front-wheel pump 210F is also actuated by operation of the downstream motor 512. Thus, the replenishment valve 504F is opened in the front-wheel slip control device 500F so as not to supply any current to the coil 530 of the front-wheel linear valve 506F, whereby the working fluid is circulated as indicated by the solid line R4. Since no current is supplied to the coil 530 of the front-wheel linear valve 506F, the hydraulic pressure in the front-wheel brake cylinders 6 and the hydraulic pressure in the pressure chamber 42 become substantially equal to each other.

In the case of making the hydraulic pressure in the front-wheel brake cylinders 6 higher than the hydraulic pressure in the pressure chamber 42, a current having a magnitude determined based on the table illustrated in FIG. 10 and the target pressure differential is supplied to the coil 530 of the front-wheel linear valve 506F. The target pressure differential is obtained based on the target hydraulic pressure for the front-wheel brake cylinders 6 and a detection value of the master-cylinder-pressure sensor 510. While the working fluid discharged from the front-wheel pump 210F is supplied to the front-wheel brake cylinders 6 while the front-wheel linear valve 506F is closed. As a result, the hydraulic pressure in the front-wheel brake cylinders 6 is controlled to a value that is higher than the hydraulic pressure in the pressure chamber 42 by the target pressure differential.

In the present embodiment, not the accumulator pressure but the working fluid discharged from the rear-wheel pump 210R is used to control the input hydraulic pressure with control of the rear-wheel linear valve 506R and the downstream motor 512. This configuration can reduce rapid change in the input hydraulic pressure, thereby satisfactorily bringing the input hydraulic pressure closer to the target hydraulic pressure. Also, the rear-wheel brake cylinders 12 are connected to the input chamber 124, allowing reduction in the stiffness of the working fluid in the input chamber 124. This construction can further reduce the rapid change in the hydraulic pressure in the input chamber 124, thereby improving controllability. Also, the input hydraulic pressure is controlled using the rear-wheel pump 210R, the downstream motor 512, and the rear-wheel linear valve 506R of the rear-wheel slip control device 500R. These devices of the rear-wheel slip control device 500R are also used for controlling slip of the rear wheels. This configuration can reduce the size of the hydraulic brake system, resulting in reduced cost.

In Slip Control

The hydraulic pressure in the rear-wheel brake cylinders 12RL, 12RR is controlled by the rear-wheel linear valve 506R using the working fluid discharged from the rear-wheel pump 210R and controlled individually by control of opening and closing of the respective pressure increase valves 202RL, 202RR and the respective pressure reduction valves 204RL, 204RR. The hydraulic pressure in the front-wheel brake cylinders 6FL, 6FR is controlled by the front-wheel linear valve 506F and controlled individually by control of opening and closing of the respective pressure increase valves 202FL, 202FR and the respective pressure reduction valves 204FL, 204FR. With these operations, the slip state of each of the rear wheels 8RL, 8RR and the front wheels 2FL, 2FR is kept within the appropriate range determined by the coefficient of friction of the road surface. Even in the case where the brake pedal 24 is not operated, the discharge pressure of the rear-wheel pump 210R and the front-wheel pump 210F can be used to supply the hydraulic pressure to the brake cylinders 12, 6, enabling execution of various kinds of control such as traction control and vehicle stability control.

In the Event of Malfunction in Electrical System

As in the first embodiment, the regulator 92 is actuated by the pilot pressure to produce the output hydraulic pressure. In the master cylinder 26, the pressurizing piston 32 is moved forward, whereby hydraulic pressure higher than the manual pressure is produced in the pressure chamber 42 and supplied to the front-wheel brake cylinders 6. In contrast, the rear-wheel brake cylinders 12 communicate with the master reservoir 82, and thus no hydraulic pressure is produced in the rear-wheel brake cylinders 12.

In view of the above, in the present embodiment, the input-hydraulic-pressure control device is constituted by, e.g., the rear-wheel pump 210R, the downstream motor 512, the rear-wheel linear valve 506R, and a portion of the brake ECU 20 which controls the downstream motor 512 and the rear-wheel linear valve 506R.

### Sixth Embodiment

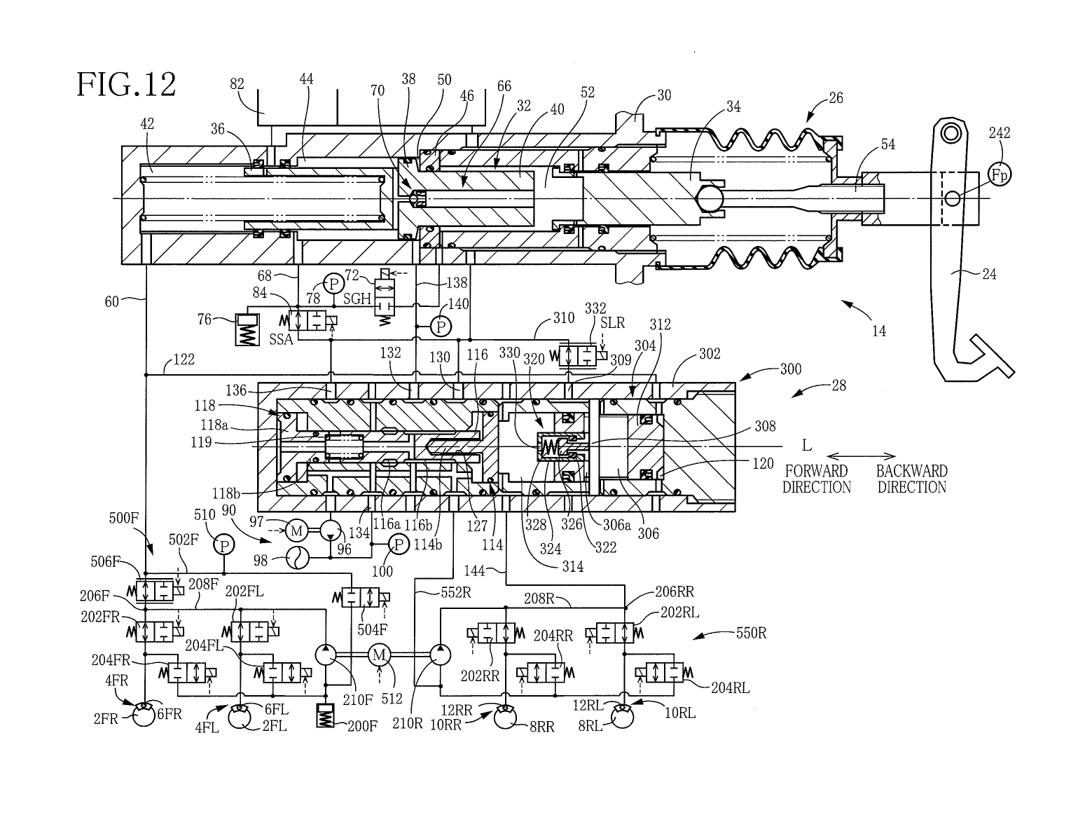

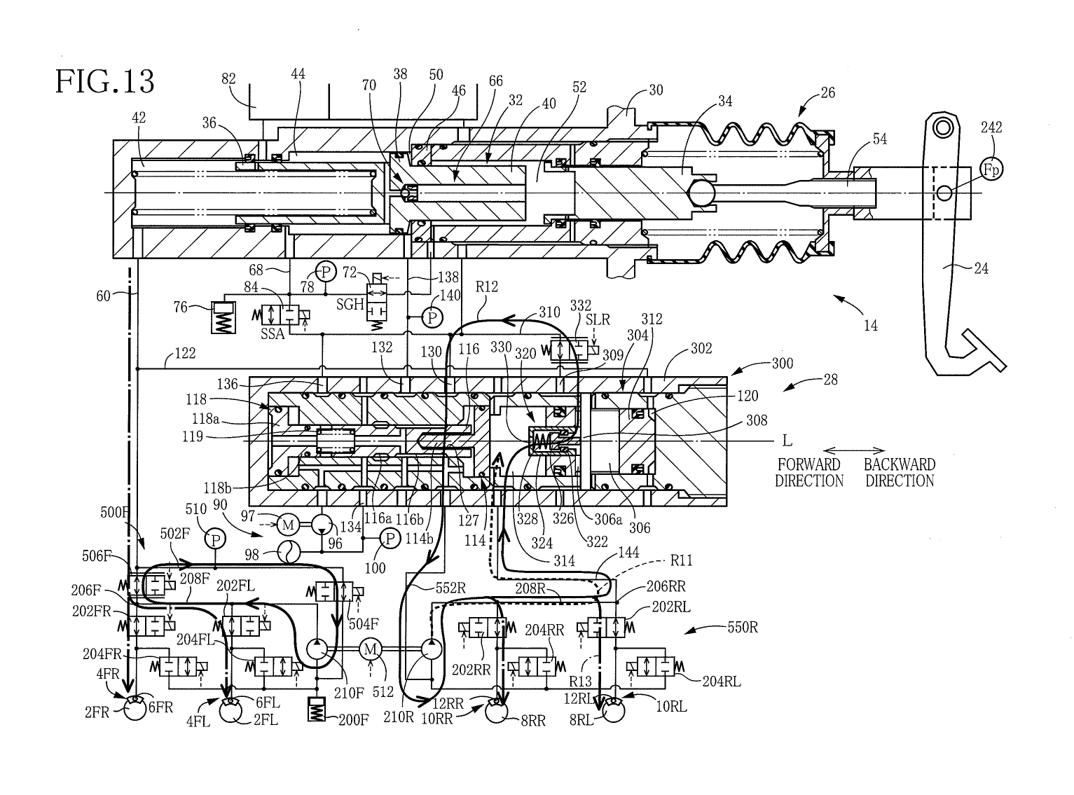

FIG. 12 illustrates a hydraulic brake system according to a sixth embodiment. The hydraulic brake system illustrated in FIG. 12 is a combination of the hydraulic-pressure producing device 14 of the hydraulic brake system according to the second embodiment and the front-wheel slip control device 500F of the hydraulic brake system according to the fifth embodiment. The hydraulic brake system illustrated in FIG. 12 differs from the hydraulic brake system according to the fifth embodiment in a rear-wheel slip control device. It is noted that the same reference numerals as used in the second and fifth embodiments are used to designate the corresponding elements in FIGS. 12 and 13, and an explanation and drawings of which are dispensed with.

### Configuration

As illustrated in FIG. 12, a rear-wheel slip control device 550R differs from the rear-wheel slip control device 500R in that no pressure-reduction reservoir is provided, in that a replenishment passage 552R is provided so as to connect between a suction side of the rear-wheel pump 210R and the reservoir passage 310 (specifically, a portion of the reservoir passage 310 which is located downstream of the pressure-reduction linear valve 332), in that no replenishment valve is provided in the replenishment passage 552R, and in mounting position of the rear-wheel linear valve, for example. In other words, the pressure-reduction linear valve 332 also serves as the rear-wheel linear valve.

### Operations

In the Case Where System Operates Normally

In Normal Braking

In the present embodiment, only operations of a rear-wheel line will be explained, without explaining operations of a front-wheel line, which are the same as those in the fifth embodiment. As illustrated in FIG. 13, the pilot piston 304 is located at its back end position, and thus the cut-off valve 320 is open. The input chamber 314 can communicate with the master reservoir 82 via the cut-off valve 320, the low pressure chamber 306a, and the reservoir passage 310. The downstream motor 512 is driven to actuate the rear-wheel pump 210R. While the pressure-reduction linear valve 332 is kept closed, the working fluid discharged from the rear-wheel pump 210R is supplied to the input chamber 314 as indicated by the broken line R11. When the pressure-reduction linear valve 332 is opened, the working fluid is returned to the suction side of the rear-wheel pump 210R via the reservoir passage 310 and the replenishment passage 552R as indicated by the solid line R12. That is, the working fluid is sucked and discharged by the rear-wheel pump 210R and circulated. The hydraulic pressure discharged from the rear-wheel pump 210R and controlled, in other words, the hydraulic pressure in the input chamber 314 is supplied to the rear-wheel brake cylinders 12 as indicated by the one-dot chain line R13, whereby the hydraulic pressure in the rear-wheel brake cylinders 12 is made equal in magnitude to the hydraulic pressure in the input chamber 314.

In the present embodiment, the hydraulic pressure in the input chamber 314 is controlled by control of the pressure-reduction linear valve 332 and the downstream motor 512, and the rear-wheel brake cylinders 12 are connected to the input chamber 314. This configuration can improve controllability of the hydraulic pressure in the input chamber 314, thereby improving controllability of the hydraulic pressure in the rear-wheel brake cylinders 12.

It is noted that, in the present embodiment, the input-hydraulic-pressure control device is constituted by, e.g., the rear-wheel pump 210R, the downstream motor 512, the pressure-reduction linear valve 332, and the brake ECU 20. The rear-wheel pump 210R, the downstream motor 512, and the pressure-reduction linear valve 332 are components of the rear-wheel slip control device 550R.

In Slip Control

The hydraulic pressure in the rear-wheel brake cylinders 12RL, 12RR is controlled by control of the pressure-reduction linear valve 332 and controlled individually by control of opening and closing of the respective pressure increase valves 202RL, 202RR and the respective pressure reduction valves 204RL, 204RR, whereby the slip state of each of the rear wheels 8RL, 8RR is kept within the appropriate range with respect to the coefficient of friction of the road surface.

In the Event of Malfunction in Electrical System

In the event of malfunction in the electrical system, the pilot piston 304 is moved forward by the pilot pressure (i.e., the hydraulic pressure in the pressure chamber 42). The cut-off valve 320 is kept closed to isolate the input chamber 314 from the master reservoir 82. The hydraulic pressure in the input chamber 314 is increased by forward movement of the pilot piston 304 and supplied to the rear-wheel brake cylinders 12, thereby actuating the hydraulic brakes 10.

While the embodiments have been described above, it is to be understood that the above-described configurations may be combined with each other. The regulator may not be connected to the rear chamber of the master cylinder, and the brake cylinders provided on the front and rear wheels may be connected to the regulator. Also, the present hydraulic brake system may be mounted on hybrid vehicles, electric vehicles, fuel-cell vehicles, and internal combustion engined vehicles.

It is to be understood that the disclosure is not limited to the details of the illustrated embodiments, but may be embodied with various changes and modifications, which may occur to those skilled in the art, without departing from the spirit and scope of the disclosure.

What is claimed is:

1. A brake-hydraulic-pressure control device, comprising:
a regulator comprising a movable member which is driven by input hydraulic pressure as hydraulic pressure in an input chamber, the regulator being capable of controlling output hydraulic pressure using movement of the movable member; and
an input-hydraulic-pressure control device capable of controlling the input hydraulic pressure to control hydraulic pressure in a plurality of brake cylinders,
the plurality of brake cylinders comprising at least one brake cylinder as a first brake cylinder connected to the input chamber.

2. The brake-hydraulic-pressure control device according to claim 1,
wherein the input-hydraulic-pressure control device comprises:
at least one electromagnetic valve each provided between the input chamber and at least one of a high pressure source and a low pressure source; and
an electromagnetic valve controller configured to control the at least one electromagnetic valve to control the input hydraulic pressure, and
wherein the brake-hydraulic-pressure control device further comprises a first brake-cylinder hydraulic controller configured to control the at least one electromagnetic valve to control hydraulic pressure in the first brake cylinder.

3. The brake-hydraulic-pressure control device according to claim 1,
wherein the output hydraulic pressure output from the regulator is suppliable to a rear chamber formed at a rear of a pressurizing piston of a master cylinder,
wherein the plurality of brake cylinders comprise at least one brake cylinder other than the first brake cylinder, as a second brake cylinder connected to a pressure chamber formed in front of the pressurizing piston, and
wherein the first brake cylinder is provided on each of rear left and right wheels of a vehicle, and the second brake cylinder is provided on each of front left and right wheels of the vehicle.

4. The brake-hydraulic-pressure control device according to claim 1,
wherein the regulator comprises a housing and an output port formed in the housing to output the output hydraulic pressure,
wherein the regulator is configured to use movement of the movable member to cause one of a high pressure source and a low pressure source to communicate selectively with the output port to control the output hydraulic pressure based on the input hydraulic pressure,
wherein the high pressure source comprises an accumulator configured to accumulate working fluid in a state in which pressure of the working fluid is greater than or equal to set pressure, and
wherein the accumulator is connected to the input chamber.

5. The brake-hydraulic-pressure control device according to claim 1,
wherein the regulator comprises:
a housing;
a pilot piston fluid-tightly and slidably fitted in the housing and disposed at a rear of the movable member, the pilot piston being movable forward by pilot pressure;
a low pressure port formed in the housing and connected to the low pressure source; and
an interrupting mechanism configured to cause the input chamber and the low pressure port to communicate with each other when the pilot piston is located at a back end position thereof, the interrupting mechanism configured to isolate the input chamber from the low pressure port when the pilot piston is moved forward.
